(19) United States
(12) Patent Application Publication
(10) Pub. No.: US 2019/0265734 A1
(43) Pub. Date: Aug. 29, 2019

(54) METHOD AND SYSTEM FOR IMAGE-BASED OBJECT DETECTION AND CORRESPONDING MOVEMENT ADJUSTMENT MANEUVERS

(71) Applicant: SZ DJI TECHNOLOGY CO., LTD., Shenzhen (CN)

(72) Inventors: Ang LIU, Shenzhen (CN); Litian ZHANG, Shenzhen (CN); Cong ZHAO, Shenzhen (CN); Zhanpeng HE, Shenzhen (CN); Shuyuan MAO, Shenzhen (CN)

(21) Appl. No.: 16/407,432

(22) Filed: May 9, 2019

Related U.S. Application Data
(63) Continuation of application No. PCT/CN2016/105960, filed on Nov. 15, 2016.

(51) Int. Cl. G05D 1/10; G05D 1/12; G06K 9/00; B64C 39/02; G05D 1/00; G06T 7/246

(52) U.S. Cl. CPC G05D 1/101; G05D 1/12; G06K 9/00637; B64C 39/024; G05D 1/0094; G06T 2207/10032; B64C 2201/127; B64C 2201/123; B64C 2201/141; G06T 2207/10028; G06T 7/248

(57) ABSTRACT

An obstacle detection method includes obtaining a base image captured by a camera of a moveable object while the moveable object is at a first position and extracting an original patch from the base image. The original patch corresponds to a portion of the base image that includes a feature point. The method further includes obtaining a current image captured by the camera while the moveable object is at a second position, determining a scale factor between the original patch and an updated patch in the current image that corresponds to a portion of the current image that includes the feature point with an updated location, and obtaining an estimate of a corresponding object depth for the feature point in the current image based on the scale factor and a distance between the first position and the second position.

### CROSS-REFERENCE TO RELATED APPLICATION

This application is a continuation of International Application No. PCT/CN2016/105960, filed on Nov. 15, 2016, the entire content of which is incorporated herein by reference.

### TECHNICAL FIELD

The disclosed embodiments relate generally to systems and methods for detecting objects (e.g., targets and/or obstacles), and adjusting movement of a moveable object in accordance with the detection results, and more particularly, but not exclusively, to obstacle detection and avoidance based on images captured by a single camera onboard a moveable object (e.g., an unmanned aerial vehicle (UAV)).

### BACKGROUND

Moveable objects such as unmanned aerial vehicles (UAVs) frequently use imaging devices to capture image data during movement of the moveable objects. The captured image data may be transmitted to a remote device, such as a remote control unit, so that a user can view the image data in real-time and control the movement of the UAV remotely. Micro-Aerial Vehicle (MAV) is a type of remotely controlled UAVs that have a size as small as a few centimeters to tens of centimeters. These small crafts allow remote observation of hazardous environments inaccessible to ground vehicles, personnel, and/or larger aerial vehicles. Autonomous control of UAVs is enabled by sensors and computation logic that are implemented to detect obstacles in the UAV's flightpath and execute obstacle avoidance maneuvers accordingly with minimal human intervention. Typically, obstacle detection on a UAV relies on signals from sensors, such as sonars, radars, stereo cameras, etc., that are carried as payload on the UAV. Data from these sensors are analyzed in real-time (e.g., based on time of flight, triangulation, etc.) to obtain size and position information of obstacles in the UAV's flight path. Based on the result of the analysis, obstacle avoidance logic implemented on the UAV modifies the flight path of the UAV to avoid the detected obstacles.

### SUMMARY

Conventional systems and methods for obstacle detection and avoidance that are implemented on UAVs require a significant amount of equipment (e.g., multiple sensors, stereo camera, etc.) to be carried on the UAVs, which reduces the maneuverability of the UAVs, increases power consumption and reduces the total flight time of the UAVs, lowers the maximum height and speed of the UAVs, and increases the complexity and cost of the UAVs. The different existing obstacle detection techniques also have various other issues, such as short detection ranges (e.g., as with ultrasound-based sensors), high cost (e.g. as with laser-based sensors), and constraints on operating environment (e.g., as with stereo cameras), that prohibit wide applicability of these detection techniques. In many cases, the small size and weight of the moveable object (e.g., as in MAVs) further limit the usefulness of these existing obstacle detection techniques, as the required equipment for obstacle detection would often take up too much of the payload permitted onboard the moveable objects.

In addition, many conventional obstacle detection techniques only work well in detecting obstacles that are relatively close to the moveable object. In such cases, by the time that the obstacles are detected, the moveable object is already very close to the detected obstacles. Due to the short distance that is still available between the moveable object and the detected obstacle, conventional obstacle avoidance techniques often require a sudden stop of the moveable object and an immediate straight pulling up of the moveable object to avoid impact with the obstacle. This type of obstacle avoidance maneuvers is often unsuccessful and places undesirable strains on the actuators of the moveable object. In addition, during obstacle avoidance, suspension of other functions (e.g., surveillance) of the moveable object may be required.

Therefore, there is a need for systems and methods of obstacle detection and handling that are effective and efficient, that do not significantly increase the cost and weight of the moveable objects, and that are capable of detecting obstacles at a relatively large distance away from the moveable object. In addition, there is a need for systems and methods of adjusting movement of the moveable object (e.g., to avoid obstacles and/or to move toward objects of interest) in accordance with results of object detection, without requiring sudden change of directions and over straining the movement mechanisms of the moveable object.

The system and method disclosed herein rely on images captured by a single onboard camera of a moveable object (e.g., a UAV or other moveable object) to detect objects (e.g., targets and/or obstacles) in the field of view of the camera and to estimate the distances of the objects from the moveable object. As most moveable objects (e.g., UAVs) already have a high-quality camera onboard (e.g., either as payload or as an integrated component), minimal additional weight and equipment need to be added to the moveable objects in order to accomplish the object detection (e.g., obstacle detection and/or target detection) goals. Accordingly, the techniques disclosed herein save costs and conserve payload allowance for other useful functions that need to be implemented on the moveable objects. In addition, most moveable objects are already capturing images during movement of the moveable object for an intended purpose (e.g., surveillance), therefor, the techniques disclosed herein are unlikely to interfere with the existing functions of the moveable objects.

Furthermore, the object detection techniques disclosed herein are capable of detecting an object that is relatively far away from the moveable object (e.g., 100 to 200 meters away), thus, smooth obstacle avoidance maneuvers can be executed successfully. In some embodiments, the moveable object, upon detection of an obstacle in its path, starts a gradual climb or a gradual sideways movement to avoid the obstacle, rather than executing a sudden stop followed by a straight up or straight side movement at high speeds. These more gradual and smooth maneuvers enabled by the object detection techniques place less strain on the movement mechanisms of the moveable objects, thereby extending the lifetime of the moveable objects.

As disclosed herein, the image processing and computations for object detection are performed in real-time onboard the moveable object in accordance with some embodiments. In some embodiments, the image processing and computations for object detection are performed in real-time or at a later time at a remote control unit in accordance with some embodiments. In some embodiments, the movement adjustment instructions (e.g., to avoid a detected obstacle) are generated onboard the moveable object in real-time (e.g., as in an autonomous flight control mode) during an autonomous flight. In some embodiments, the movement adjustment instructions (e.g., to avoid a detected obstacle) are generated at the remote control unit and transmitted to the moveable object during a controlled or semi-controlled flight. In some embodiments, both the object detection and the movement adjustments are implemented onboard the moveable object (e.g., an MAV), such that autonomous flight control of the MAV is accomplished.

In accordance with some embodiments, a method of obstacle detection is performed at a device having one or more processors and memory. The method includes: obtaining a base image that is captured by an onboard camera of a moveable object while the moveable object is at a first position; extracting a first original patch from the base image, wherein the first original patch corresponds to a portion of the base image that includes a first feature point of the base image; obtaining a current image that is captured by the onboard camera while the moveable object is at a second position, wherein a portion of the current image includes the first feature point with an updated location; determining a first scale factor between the first original patch in the base image and a first updated patch in the current image, wherein the first updated patch corresponds to the portion of the current image that includes the first feature point with the updated location; and based on the first scale factor and a distance between the first position and the second position of the moveable object, obtaining an estimate of a corresponding object depth for the first feature point in the current image.

In some embodiments, an Unmanned Aerial Vehicle (UAV) includes: a propulsion system; an onboard camera; a storage device; and one or more processors coupled to the propulsion system, the onboard camera, and the storage device; the one or more processors configured for: obtaining a base image that is captured by the onboard camera while the UAV is at a first position; extracting a first original patch from the base image, wherein the first original patch corresponds to a portion of the base image that includes a first feature point of the base image; obtaining a current image that is captured by the onboard camera while the UAV is at a second position along the original movement path of the UAV, and wherein a portion of the current image includes the first feature point with an updated location; determining a first scale factor between the first original patch in the base image and a first updated patch in the current image, wherein the first updated patch corresponds to the portion of the current image that includes the first feature point with the updated location; and based on the first scale factor and a distance between the first position and the second position of the UAV, obtaining an estimate of a corresponding object depth for the first feature point in the current image.

In some embodiments, a system includes: a storage device; and one or more processors coupled to the propulsion system and the storage device; the one or more processors configured for: obtaining a base image that is captured by an onboard camera of a moveable object while the moveable object is at a first position; extracting a first original patch from the base image, wherein the first original patch corresponds to a portion of the base image that includes a first feature point of the base image; obtaining a current image that is captured by the onboard camera while the moveable object is at a second position (e.g., a second position along the original movement path of the moveable object), and wherein a portion of the current image includes the first feature point with an updated location; determining a first scale factor between the first original patch in the base image and a first updated patch in the current image, wherein the first updated patch corresponds to the portion of the current image that includes the first feature point with the updated location; and based on the first scale factor and a distance between the first position and the second position of the moveable object, obtaining an estimate of a corresponding object depth for the first feature point in the current image.

In some embodiments, a computer readable storage medium stores one or more programs, the one or more programs comprising instructions, which when executed, cause a device to: obtain a base image that is captured by an onboard camera of a moveable object while the moveable object is at a first position (e.g., a first position along an original movement path of the moveable object); extract a first original patch from the base image, wherein the first original patch corresponds to a portion of the base image that includes a first feature point of the base image; obtain a current image that is captured by the onboard camera while the moveable object is at a second position (e.g., a second position along the original movement path of the moveable object), and wherein a portion of the current image includes the first feature point with an updated location; determine a first scale factor between the first original patch in the base image and a first updated patch in the current image, wherein the first updated patch corresponds to the portion of the current image that includes the first feature point with the updated location; and based on the first scale factor and a distance between the first position and the second position of the moveable object, obtain an estimate of a corresponding object depth for the first feature point in the current image.

In some embodiments, a method of obstacle avoidance is performed at a moveable object having an onboard camera, one or more processors, and memory. The method includes: detecting an obstacle in an original movement path of the moveable object; in response to detecting the obstacle: in accordance with a determination that long-range obstacle avoidance criteria are met, wherein the long-range obstacle criteria require that a distance between the moveable object and the obstacle along the original movement path exceeds a first threshold distance, executing a long-range obstacle avoidance maneuver, including moving along an initial trajectory from a current position of the moveable object to a point of clearance beyond an outer edge of the obstacle, wherein an initial velocity of the moveable object along the initial trajectory has a first component that is parallel to the original movement path and a second component that is perpendicular to the original movement path.

In some embodiments, a Micro aerial vehicle (MAV) includes a propulsion system; an onboard camera; a storage device; and one or more processors coupled to the propulsion system, the onboard camera, and the storage device; the one or more processors configured for: detecting an obstacle in an original movement path of the moveable object; in response to detecting the obstacle: in accordance with a determination that long-range obstacle avoidance criteria are met, wherein the long-range obstacle criteria require that a distance between the moveable object and the obstacle along the original movement path exceeds a first threshold distance, executing a long-range obstacle avoidance maneuver, including moving along an initial trajectory from a current position of the moveable object to a point of clearance beyond an outer edge of the obstacle, wherein an initial velocity of the moveable object along the initial trajectory has a first component that is parallel to the original movement path and a second component that is perpendicular to the original movement path.

In some embodiments, a system includes: an onboard camera; a storage device; and one or more processors coupled to the propulsion system, the onboard camera, and the storage device; the one or more processors configured for: detecting an obstacle in an original movement path of the moveable object; in response to detecting the obstacle: in accordance with a determination that long-range obstacle avoidance criteria are met, wherein the long-range obstacle criteria require that a distance between the moveable object and the obstacle along the original movement path exceeds a first threshold distance, executing a long-range obstacle avoidance maneuver, including moving along an initial trajectory from a current position of the moveable object to a point of clearance beyond an outer edge of the obstacle, wherein an initial velocity of the moveable object along the initial trajectory has a first component that is parallel to the original movement path and a second component that is perpendicular to the original movement path.

In some embodiments, a computer readable storage medium stores one or more programs, the one or more programs comprising instructions, which when executed, cause a device to: detect an obstacle in an original movement path of the moveable object; in response to detecting the obstacle: in accordance with a determination that long-range obstacle avoidance criteria are met, wherein the long-range obstacle criteria require that a distance between the moveable object and the obstacle along the original movement path exceeds a first threshold distance, execute a long-range obstacle avoidance maneuver, including moving along an initial trajectory from a current position of the moveable object to a point of clearance beyond an outer edge of the obstacle, wherein an initial velocity of the moveable object along the initial trajectory has a first component that is parallel to the original movement path and a second component that is perpendicular to the original movement path.

In accordance with some embodiments, an electronic device includes a propulsion system; an onboard camera; a storage device; and one or more processors coupled to the propulsion system, the onboard camera, and the storage device; the one or more processors configured for performing any of the methods described herein. In accordance with some embodiments, a computer readable storage medium has stored therein instructions which when executed by an electronic device, cause the device to perform or cause performance of the operations of any of the methods described herein. In accordance with some embodiments, an electronic device includes: means for performing or causing performance of the operations of any of the methods described herein.

### BRIEF DESCRIPTION OF THE DRAWINGS

FIG. 1 is a schematic diagram of a moveable object environment, in accordance with some embodiments.

FIG. 2 is a system diagram of an exemplary moveable object, in accordance with some embodiments.

FIG. 3 is a system diagram of an exemplary control unit, in accordance with some embodiments.

FIG. 4 is a schematic diagram that illustrates image capturing, obstacle detection, and obstacle avoidance, during flight of an MAV, in accordance with some embodiments.

FIG. 5 illustrates detection and tracking of feature points and matching corresponding image patches across two images that are captured by a single onboard camera at different positions along the movement path of the moveable object, in accordance with some embodiments.

FIG. 6 illustrates feature points and corresponding patches in an image, in accordance with some embodiments.

FIG. 7 illustrates the selection of an initial value for a scale factor s for an image patch corresponding to a detected feature point, in accordance with some embodiments.

FIG. 8 illustrates the calculation of an object depth of a feature point based on a scale factor between corresponding sizes of a real-world object shown in two images that are captured at different positions F1 and F2, in accordance with some embodiments.

FIG. 9 illustrates detection of open sky and characterization of detected obstacles based on estimated object depths of feature points in an image, in accordance with some embodiments.

FIG. 10 illustrates projection of feature points from a base image and a previous base image onto a current image, in accordance with some embodiments.

FIG. 11 illustrate a process for searching for a window of clearance to avoid an obstacle, in accordance with some embodiments.

FIG. 12 illustrates paths of long-range obstacle avoidance maneuvers, in accordance with some embodiments.

FIGS. 13A-13E are a flow diagram of a method for estimating object depth based on images captured at different locations (e.g., by a single camera), in accordance with some embodiments.

FIGS. 14A-14G are a flow diagram of a method for avoiding an obstacle, in accordance with some embodiments.

FIG. 15 is a block diagram of a moveable object (e.g., an MAV) that implements the object detection and/or avoidance techniques disclosed herein.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Techniques for detecting objects, specifically, estimating locations, sizes, and distances of objects (e.g., targets and/or obstacles) based on images captured by a single camera are described herein. In addition, techniques for adjusting movements of a moveable object (e.g., executing long-range and short-range obstacle avoidance maneuvers) in accordance with object detection results are also described herein.

In some embodiments, the images are captured using a camera that is a payload or an integrated component of a UAV or other remote controlled and/or autonomous vehicle. When image data is captured by a device (such as a UAV or other moveable object) that is remote from a user operated device (such as a remote control device for a UAV), the image data can be transmitted to the user operated device, so that the user is able to, e.g., view the image data that is being captured, direct image capture properties, and direct movement of the moveable object based on the imaged subject. However, sometimes, distance determination for objects in the captured images is difficult based on the use's naked eye. In addition, sometimes, direct user control is not available or desirable, and the moveable object must rely on preconfigured and/or automatically generated computer instructions to determine how to navigate around objects in its flight path. In these scenarios, automatic object detection and distance estimation are required to provide a basis for the automatic generation of computer instructions to adjust the movement of the unmanned moveable object, and/or for aiding a human user to manually navigate the moveable object accordingly.

In some embodiments, the captured image data can also be processed at the user operated device or using the onboard processing units of the UAV in accordance with the techniques described herein to determine whether targets and/or obstacles exist in the UAV's field of view and characterize the locations and sizes of the targets and/or obstacles. In the case where an obstacle is detected in the original movement path of the UAV, or where an object of interest is detected in the field of view of the UAV, instructions can be generated at the control device or onboard the UAV for the UAV to execute appropriate obstacle avoidance maneuvers or to head toward the object of interest that has been detected.

In some embodiments, based on the characterization of the obstacles (e.g., approximation of the sizes, shapes, and locations of the obstacles) detected in the moveable object's field of view, given that a sufficient distance between the detected obstacle and the moveable object exists, instructions are generated to adjust the original movement path of the moveable object in a gradual and smooth manner, without requiring a sudden stop followed by a straight pull-up or a straight side movement, to avoid the obstacle.

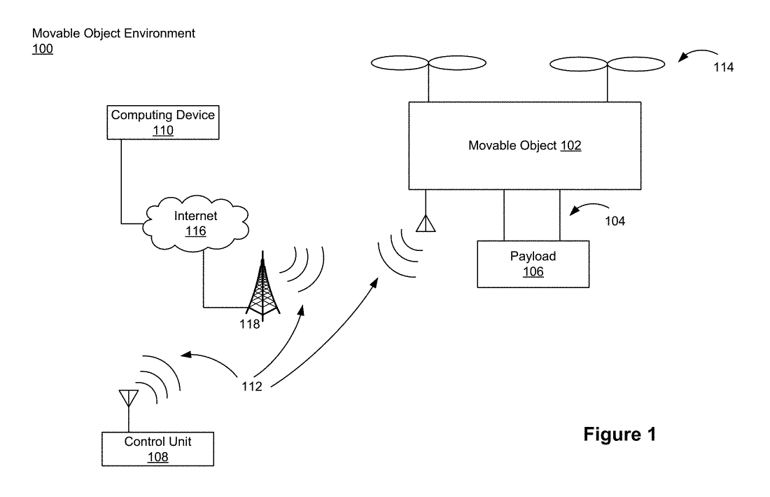

FIG. 1 illustrates a moveable object environment 100, in accordance with some embodiments. The moveable object environment 100 includes a moveable object 102. In some embodiments, the moveable object 102 includes a carrier 104, a payload 106, and/or one or more movement mechanisms 114.

In some embodiments, the carrier 104 is used to couple a payload 106 to moveable object 102. In some embodiments, the carrier 104 includes an element (e.g., a gimbal and/or damping element) to isolate the payload 106 from movement of the moveable object 102 and/or the one or more movement mechanisms 114. In some embodiments, the carrier 104 includes an element for controlling movement of the payload 106 relative to the moveable object 102.

In some embodiments, the payload 106 is coupled (e.g., rigidly coupled) to the moveable object 102 (e.g., coupled via the carrier 104) such that the payload 106 remains substantially stationary relative to the moveable object 102. For example, the carrier 104 is coupled to the payload 106 such that the payload is not movable relative to the moveable object 102. In some embodiments, the payload 106 is mounted directly to the moveable object 102 without requiring the carrier 104. In some embodiments, the payload 106 is located partially or fully within the moveable object 102.

In some embodiments, the moveable object environment 100 includes a control unit 108 that communicates with the moveable object 102, e.g., to provide control instructions to the moveable object 102 and/or to display information received from the moveable object 102.

In some embodiments, the moveable object environment 100 includes a computing device 110. The computing device 110 is, e.g., a server computer, desktop computer, a laptop computer, a tablet, or another portable electronic device (e.g., a mobile telephone). In some embodiments, the computing device 110 is a base station that communicates (e.g., wirelessly) with the moveable object 102 and/or the control unit 108. In some embodiments, the computing device 110 provides data storage, data retrieval, and/or data processing operations, e.g., to reduce the processing power and/or data storage requirements of the moveable object 102 and/or the control unit 108. For example, the computing device 110 is communicatively connected to a database and/or the computing device 110 includes a database. In some embodiments, the computing device 110 is used in lieu of or in addition to the control unit 108 to perform any of the operations described with regard to the control unit 108.

In some embodiments, the moveable object 102 communicates with a control unit 108 and/or a computing device 110, e.g., via wireless communications 112. In some embodiments, the moveable object 102 receives information from the control unit 108 and/or the computing device 110. For example, information received by the moveable object 102 includes, e.g., control instructions for controlling parameters of the moveable object 102. In some embodiments, the moveable object 102 transmits information to the control unit 108 and/or the computing device 110. For example, information transmitted by the moveable object 102 includes, e.g., images and/or video captured by the moveable object 102.

In some embodiments, communications between the computing device 110, the control unit 108 and/or the moveable object 102 are transmitted via a network (e.g., Internet 116) and/or a wireless signal transmitter (e.g., a long range wireless signal transmitter) such as a cellular tower 118. In some embodiments, a satellite (not shown) is a component of Internet 116 and/or is used in addition to or in lieu of the cellular tower 118.

In some embodiments, information communicated between the computing device 110, the control unit 108 and/or the moveable object 102 include control instructions. Control instructions include, e.g., navigation instructions for controlling navigational parameters of the moveable object 102 such as position, orientation, attitude, and/or one or more movement characteristics (e.g., velocity and/or acceleration for linear and/or angular movement) of the moveable object 102, the carrier 104, and/or the payload 106. In some embodiments, control instructions include instructions for directing movement of one or more of the movement mechanisms 114. For example, control instructions are used to control flight of a UAV (e.g., to execute obstacle avoidance maneuvers, and/or follow an object of interest).

In some embodiments, control instructions include information for controlling operations (e.g., movement) of the carrier 104. For example, control instructions are used to control an actuation mechanism of the carrier 104 so as to cause angular and/or linear movement of the payload 106 relative to the moveable object 102. In some embodiments, control instructions adjust movement of the moveable object 102 with up to six degrees of freedom.

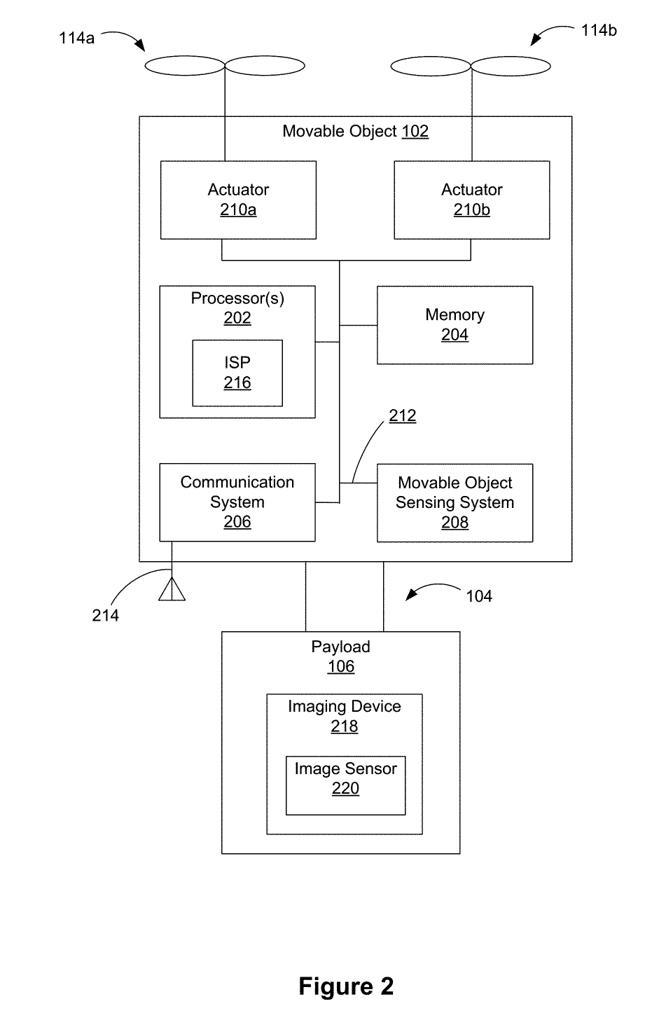

In some embodiments, control instructions are used to adjust one or more operational parameters for the payload 106. For example, control instructions include instructions for adjusting a focus parameter and/or an orientation of the payload 106 (e.g., to track a target). In some embodiments, control instructions include instructions for: adjusting imaging properties and/or image device functions, such as adjusting a metering mode (e.g., a number, arrangement, size, and/or location of light metering areas); adjusting one or more exposure parameters (e.g., an aperture setting, a shutter speed, and/or an exposure index); capturing an image; initiating/ceasing video capture; powering an imaging device 218 (FIG. 2) on or off; adjusting an imaging mode (e.g., capturing still images or capturing video); adjusting a distance between left and right components of a stereographic imaging system; and/or adjusting a position, orientation, and/or movement (e.g., pan rate and/or pan distance) of a carrier 104, a payload 106 and/or an imaging device 302.

In some embodiments, when control instructions are received by the moveable object 102, the control instructions change parameters of and/or are stored by the memory 204 (FIG. 2) of moveable object 102.

The above identified elements need not be implemented as separate software programs, procedures, or modules, and thus various subsets of these elements may be combined or otherwise re-arranged in various embodiments, and stored in the memory 204 and/or the processor(s) 202. In some embodiments, the controlling system includes a subset of the elements identified above. Furthermore, the memory 204 and/or the processors 202 may store additional elements not described above. In some embodiments, the elements stored in the memory 204, the processor(s) 202, and/or a non-transitory computer readable storage medium of memory 204 and/or processors(s) 202, provide instructions for implementing respective operations in the methods described below. In some embodiments, some or all of these elements may be implemented with specialized hardware circuits that subsume part or all of the element functionality. One or more of the above identified elements may be executed by one or more processor(s) 202 of the moveable object 102. In some embodiments, one or more of the above identified elements are stored on one or more storage devices of a device remote from the moveable object (such as memory of the control unit 108 and/or the computing device 110) and/or executed by one or more processors of a device remote from the moveable object 102 (such as processor(s) of the control unit 108 and/or the computing device 110).

FIG. 2 illustrates an exemplary moveable object 102, in accordance with some embodiments. The moveable object 102 typically includes one or more processor(s) 202, a memory 204, a communication system 206, a moveable object sensing system 208, and one or more communication buses 212 for interconnecting these components.

In some embodiments, the one or more processor(s) include at least one Field Programmable Gate Array (FPGA) and/or at least one Application Specific Integrated Circuit (ASIC). In some embodiments, the one or more processor(s) 202 include one or more image signal processors (ISPs) 216 (e.g., implemented in the at least one FPGA and/or the at least one ASIC).

In some embodiments, memory 204 includes a solid state drive (SSD). In some embodiments, part or all of memory 204 is connected to a communication bus 212 via a Peripheral Component Interconnect Express (PCIe) interface or Serial AT Attachment (SATA) interface connects bus.

In some embodiments, the moveable object 102 is a UAV and includes components to enable flight and/or flight control. In some embodiments, the moveable object 102 includes communication system 206 with one or more network or other communications interfaces (e.g., via which flight control instructions are received), one or more movement mechanisms 114 (e.g., 114a, 114b), and/or one or more moveable object actuators 210 (e.g., 210a, 210b). Moveable object actuators (e.g., 210a, 210b) cause movement of movement mechanisms (e.g., 114a, 114b), e.g., in response to received control instructions. Although the moveable object 102 is depicted as an aircraft, this depiction is not intended to be limiting, and any suitable type of moveable object can be used (e.g., a micro-rover).

In some embodiments, the moveable object 102 includes movement mechanisms 114 (e.g., propulsion mechanisms). Although the plural term “movement mechanisms” is used herein for convenience of reference, “movement mechanisms 114” refers to a single movement mechanism (e.g., a single propeller) or multiple movement mechanisms (e.g., multiple rotors). The movement mechanisms 114 include one or more movement mechanism types such as rotors, propellers, blades, engines, motors, wheels, axles, magnets, nozzles, and so on. The movement mechanisms 114 are coupled to the moveable object 102 at, e.g., the top, bottom, front, back, and/or sides. In some embodiments, the movement mechanisms 114 of a single moveable object 102 include multiple movement mechanisms of the same type. In some embodiments, the movement mechanisms 114 of a single moveable object 102 include multiple movement mechanisms with different movement mechanism types. The movement mechanisms 114 are coupled to the moveable object 102 using any suitable means, such as support elements (e.g., drive shafts) and/or other actuating elements (e.g., the moveable object actuators 210). For example, a moveable object actuator 210 receives control signals from the processor(s) 202 (e.g., via the control bus 212) that activate the moveable object actuator 210 to cause movement of a movement mechanism 114. For example, the processor(s) 202 include an electronic speed controller that provides control signals to a moveable object actuator 210.

In some embodiments, the movement mechanisms 114 enable the moveable object 102 to take off vertically from a surface or land vertically on a surface without requiring any horizontal movement of the moveable object 102 (e.g., without traveling down a runway). In some embodiments, the movement mechanisms 114 are operable to permit the moveable object 102 to hover in the air at a specified position and/or orientation. In some embodiments, one or more of the movement mechanisms 114 (e.g., 114a) are controllable independently of one or more of the other movement mechanisms 114 (e.g., 114b). For example, when the moveable object 302 is a quadcopter, each rotor of the quadcopter is controllable independently of the other rotors of the quadcopter. In some embodiments, multiple movement mechanisms 114 are configured for simultaneous movement.

In some embodiments, the movement mechanisms 114 include multiple rotors that provide lift and/or thrust to the moveable object 102. The multiple rotors are actuated to provide, e.g., vertical takeoff, vertical landing, and hovering capabilities to the moveable object 102. In some embodiments, one or more of the rotors spin in a clockwise direction, while one or more of the rotors spin in a counterclockwise direction. For example, the number of clockwise rotors is equal to the number of counterclockwise rotors. In some embodiments, the rotation rate of each of the rotors is independently variable, e.g., for controlling the lift and/or thrust produced by each rotor, and thereby adjusting the spatial disposition, velocity, and/or acceleration of the moveable object 102 (e.g., with respect to up to three degrees of translation and/or up to three degrees of rotation).

The communication system 206 enables communication with the control unit 108 and/or the computing device 110, e.g., via an antenna 214. The communication system 206 includes, e.g., transmitters, receivers, and/or transceivers for wireless communication. In some embodiments, the communication is one-way communication, such that data is only received by the moveable object 102 from the control unit 108 and/or the computing device 110, or vice-versa. In some embodiments, communication is two-way communication, such that data is transmitted in both directions between the moveable object 102 and the control unit 108 and/or the computing device 110. In some embodiments, the moveable object 102, the control unit 108, and/or the computing device 110 are connected to the Internet 116 or other telecommunications network, e.g., such that data generated by the moveable object 102, the control unit 108, and/or the computing device 110 is transmitted to a server for data storage and/or data retrieval (e.g., for display by a website).

In some embodiments, the sensing system 208 of the moveable object 102 includes one or more sensors. In some embodiments, the one or more sensors of moveable object sensing system 208 includes image sensor 220 (e.g., an imaging sensor of an imaging device 218, such as a digital camera). In some embodiments, one or more sensors of the moveable object sensing system 208 are mounted to the exterior, located within, or otherwise coupled to the moveable object 102. In some embodiments, one or more sensors of the moveable object sensing system 208 are components of and/or coupled to the carrier 104 and/or the payload 106. For example, part or all of imaging device 218 is a payload 106, a component of payload 106, and/or a component of moveable object 102. In some embodiments, one or more processors(s) 202, memory 204, and/or ISP(s) 216 are components of imaging device 218. The image sensor 220 is, e.g., a sensor that detects light, such as visible light, infrared light, and/or ultraviolet light. In some embodiments, the image sensor 220 includes, e.g., semiconductor charge-coupled devices (CCD), active pixel sensors using complementary metal-oxide-semiconductor (CMOS) and/or N-type metal-oxide-semiconductors (NMOS, Live MOS). In some embodiments, the image sensor 220 includes one or more arrays of photo sensors.

In some embodiments, the memory 204 stores one or more instructions, programs (e.g., sets of instructions), modules, controlling systems, controlling system configurations, and/or data structures, collectively referred to as “elements” herein. One or more elements described with regard to the memory 204 are optionally stored by the control unit 108, the computing device 110, the imaging device 218, and/or another device.

In some embodiments, the memory 204 stores a controlling system configuration that includes one or more system settings (e.g., as configured by a manufacturer, administrator, and/or user). For example, identifying information for the moveable object 102 is stored as a system setting of the system configuration. In some embodiments, the controlling system configuration includes a configuration for the moveable object sensing system 208. The configuration for the moveable object sensing system 208 stores parameters such as position (e.g., of an optical device relative to the image sensor 220), zoom level and/or focus parameters (e.g., amount of focus, selecting autofocus or manual focus, and/or adjusting an autofocus target in an image). Imaging property parameters stored by memory 204 include, e.g., frame rate, image resolution, image size (e.g., image width and/or height), aspect ratio, pixel count, quality, focus distance, depth of field, exposure time, shutter speed, and/or white balance. In some embodiments, parameters stored by memory 204 are updated in response to control instructions (e.g., generated by processor(s) 202 and/or received by the moveable object 102 from control unit 108 and/or the computing device 110).

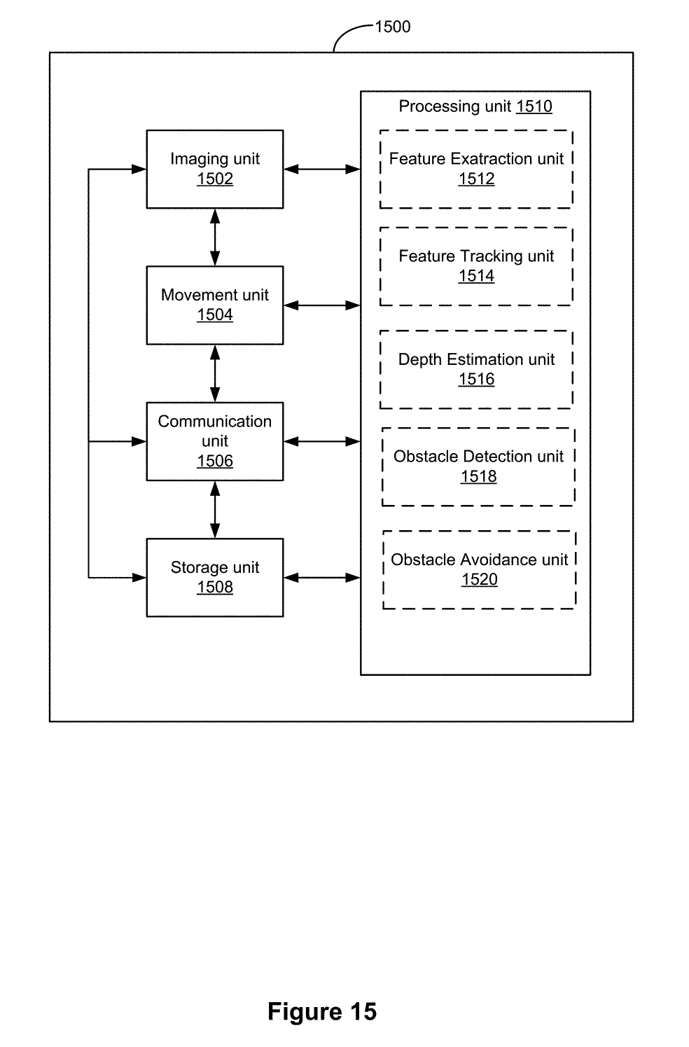

In some embodiments, the controlling system includes instructions and/or functional units for initiating and/or ceasing storage of the image data output of the image sensor 220. In some embodiments, the controlling system includes image processing instructions and/or functional units for processing high quality image data to generate raw format image data and/or to generate reduced-size image data. In some embodiments, the image processing instructions include one or more compression algorithms, such as are well-known in the art. In some embodiments, the controlling system includes instructions and/or functional units for preprocessing the high-quality image data or the reduced-size image data in preparation of the image-based object detection procedures. In some embodiments, the controlling system includes instructions and/or functional units for processing the image data to extract feature points and track the feature points across multiple images that have been taken at different locations along the moveable objects' movement path. In some embodiments, the controlling system includes instructions and/or functional units for detecting objects and estimating depths of the objects represented in the captured images (or in the field of view of the moveable object). In some embodiments, the controlling system includes instructions and/or functional units for characterizing (e.g., estimating the sizes, shapes, and locations of) the objects detected in the captured image (or in the field of view of the moveable object). In some embodiments, the controlling system includes instructions and/or functional units for generating specific instructions for adjusting the movement of the moveable object in accordance with the characterization of the objects that have been detected. In some embodiments, the controlling system includes instructions and/or functional units for executing the specific instructions for adjusting the movement of the moveable object that have been generated. FIG. 15 illustrates a functional block diagram illustrating a system that includes functional units for performing the various functions described herein.

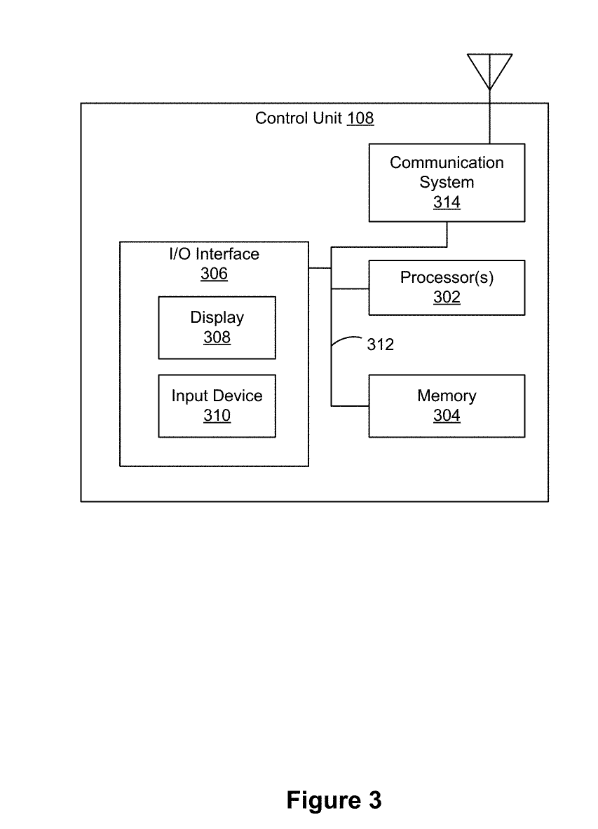

FIG. 3 illustrates an exemplary control unit 108, in accordance with some embodiments. Although the control unit 108 is typically a portable (e.g., handheld) device, the control unit 108 need not be portable. In some embodiments, the control unit 108 is a dedicated control device (e.g., for the moveable object 102), a laptop computer, a desktop computer, a tablet computer, a gaming system, a wearable device (e.g., glasses, a glove, and/or a helmet), a microphone, a portable communication device (e.g., a mobile telephone) and/or a combination thereof. The control unit 108 typically includes one or more processor(s) 302, a memory 304, an I/O interface 306, a communication system 314, and one or more communication buses 312 for interconnecting these components.

In some embodiments, I/O interface 306 includes an input device 310. In some embodiments, the input device 310 receives user input to control aspects of the moveable object 102, the carrier 104, the payload 106, and/or a component thereof. Such aspects include, e.g., altitude, position, orientation, velocity, acceleration, navigation, and/or tracking. For example, a position of an input device of the control unit 108 (e.g., a position of a component of input device) is manually set by a user to a position corresponding to an input (e.g., a predetermined input) for controlling the moveable object 102. In some embodiments, the input device is manipulated by a user to input control instructions for controlling the navigation of the moveable object 102. In some embodiments, the input device 310 of the control unit 108 is used to input a flight mode for the moveable object 102, such as auto pilot or navigation according to a predetermined navigation path.

In some embodiments, I/O interface 306 includes a display 308 of the control unit 108. In some embodiments, the display 308 displays information generated by the moveable object sensing system 208 (e.g., imaging device 218 and/or image sensor 220), the memory 204, and/or another system of the moveable object 102. For example, information displayed by a display 308 of the control unit 108 includes a processed version of image data captured by the imaging device 218 and/or image sensor 220. In some embodiments, information displayed by the display 308 is displayed in substantially real-time as information is received from the moveable object 102 and/or as image data is acquired. In some embodiments, the display 308 displays tracking data (e.g., a graphical tracking indicator applied to a representation of a target), and/or indications of control data transmitted to the moveable object 102. In some embodiments, the display 308 displays information about the moveable object 102, the carrier 104, and/or the payload 106, such as position, attitude, orientation, movement characteristics of the moveable object 102, and/or distance between the moveable object 102 and another object (e.g., a target and/or an obstacle).

In some embodiments, the control unit 108 includes instructions and/or functional units receiving and storing the image data output from the moveable object 102. In some embodiments, the control unit 108 includes instructions and/or functional units for preprocessing the image data received from the moveable object 102 in preparation of the image-based object detection procedures. In some embodiments, the control unit 108 includes instructions and/or functional units for processing the image data to extract feature points and track the feature points across multiple images that have been taken at different locations along the moveable objects' movement path. In some embodiments, the control unit 108 includes instructions and/or functional units for detecting objects and estimating depths of the objects in the captured images (or in the field of view of the moveable object). In some embodiments, the control unit 108 includes instructions and/or functional units for characterizing (e.g., estimating the sizes, shapes, and locations of) the objects detected in the captured image (or in the field of view of the moveable object). In some embodiments, the control unit 108 includes instructions and/or functional units for generating specific instructions for adjusting the movement of the moveable object in accordance with the characterization of the objects that have been detected. In some embodiments, the control unit 108 includes instructions and/or functional units for sending the specific instructions for adjusting the movement of the moveable object that have been generated. In some embodiments, the control unit 108 includes instructions for displaying the suggested movement adjustment maneuvers and/or obstacle distance data overlaid on a currently displayed/captured image on display 308, to aid the user's direct control of the moveable object.

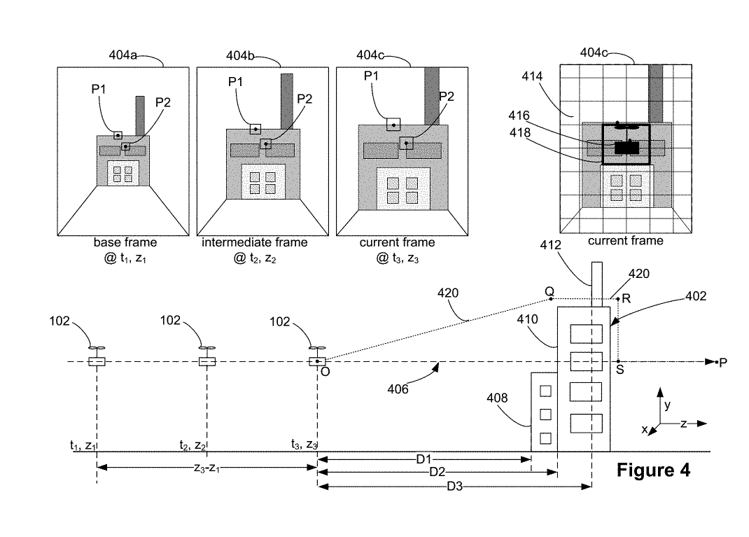

FIG. 4 is a schematic diagram that illustrates image capturing, obstacle detection, and obstacle avoidance, during flight of an MAV, in accordance with some embodiments.

As shown in FIG. 4, a series of images (e.g., images 404a through 404c) are captured by an onboard camera of a moveable object 102 (e.g., a MAV) along a movement path 406 of the moveable object 102. The captured images 404 show a building 402 (e.g., an obstacle) in the moveable object's movement path 406 (e.g., in the field of view of the onboard camera of the moveable object 102). As the moveable object 102 continues to move toward the building 402, the building (e.g., as represented by the pixels in the images 404) occupies an increasing portion of the images.

As will be discussed in more details later in this disclosure, the change in scale of an image feature (e.g., as represented by a pixel patch (P1 or P2) corresponding to a feature point (e.g., the point shown at the center of the pixel patch P1 or P2) extracted from a base image (e.g., image 404a)) across multiple images (e.g., images 404b and 404c), in conjunction with the change in the z-position of the moveable object 102 when the images were captured at different time (e.g., at t1, t2, and t3) during the movement of the moveable object, provides clues as to the z-position of the object (e.g., the facade 408 of the front portion of the building 402, the chimney stack 412 on top of the building 402, or the facade 410 of the back portion of the building 402, etc.) that is represented by an image feature in the images.

In the discussion below, the base image or base frame (e.g., image 404a) is a reference image that is associated with a real-world reference z-position (e.g., z₁) from which the z-position of an object represented in the base image is measured. As the moveable object 102 moves closer to the building 402, the distance (e.g., D1, D2, or D3) between the moveable object and the object (e.g., object 408, 410, or 412) represented in the image (e.g., image 404c) that corresponds to the current z-position (e.g., z₃) of the moveable object is estimated to be the object depth of the object in the image.

As shown in FIG. 4, two feature points with corresponding pixel patches P1 and P2 are identified in the base image 404a. The two feature points and their corresponding pixel patches P1 and P2 are tracked across multiple images (e.g., intermediate image 404b and current image 404c). The object depth of the feature points are estimated based on the scale change of the pixel patches P1 and P2 across the images 404a and 404c, and the corresponding distance (z3−z1) traveled by the moveable object. Once the object depth of the feature points are estimated. The current image 404c is divided into a grid of sub-regions (e.g., sub-region 414). The size and shape of the moveable object are projected onto the current image (e.g., as represented by shadow 416). The object depths of all sub-regions that are touched by the projection of the moveable object (e.g., as indicated by the rectangle 418 that includes multiple sub-regions) are estimated. Since the object depth of the sub-regions that are in the movement path 406 of the moveable object (e.g., the object depth of the facade of the back portion of building 402) is between the current position of the moveable object and the destination of the moveable object, these sub-regions are determined to represent an obstacle that needs to be avoided.

When an object (e.g., facade 410) detected in the field of view of the onboard camera, and the objected is determined to be an obstacle in the current flight path 406 from a current position O to a destination P of the moveable object 102, the moveable object executes obstacle avoidance maneuvers. As shown in FIG. 4, the moveable object 102 starts a gradual climb along a trajectory 420 (e.g., path with initial trajectory O-Q) toward a point of clearance Q above the obstacle (e.g., facade 410) as soon as the distance of the obstacle is determined (e.g., when the moveable object is at point O), avoiding a sudden maneuver that is required when the moveable object gets too close to the obstacle. After the gradual climb, the moveable object 102 continues forward movement toward its destination at the same altitude above the obstacle (e.g., following path QR), provided that no other obstacles are detected to warrant another obstacle avoidance maneuver to be executed, until the moveable object passes the obstacle (e.g., until point R is reached). After the moveable object has moved past the obstacle, the moveable object drops down quickly to its original altitude before the gradual climb (e.g., follows path RS) and continues to move toward the destination (e.g., following path SP).

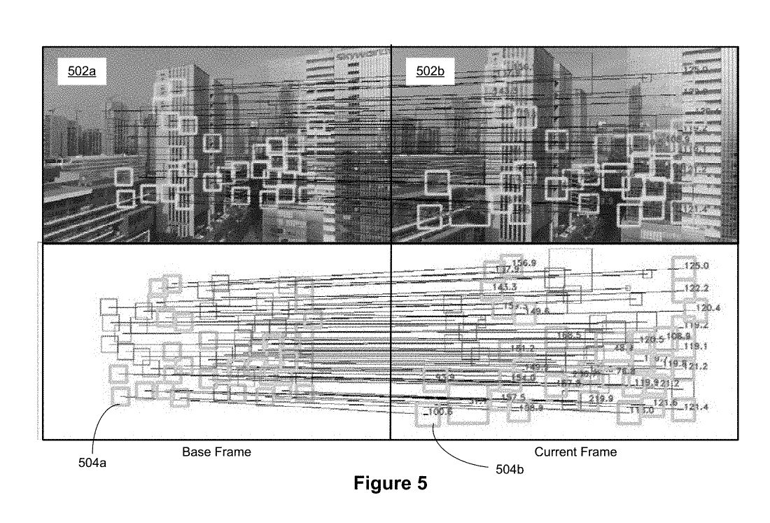

FIG. 4 is merely illustrative of a simple example scenario, and more details of the process to determine object depth, detect obstacle, and select and execute appropriate obstacle avoidance maneuvers are provided later with respect to FIGS. 5-12, for example.

FIGS. 5-12 illustrates processing of image data to detect objects in the field of view of the onboard camera, estimating the distances of the objects from the moveable object, and determining whether the objects are obstacles that need to be avoided. If an obstacle needs to be avoided, various obstacle avoidance maneuvers are implemented to adjust the movement path of the moveable object.

In some embodiments, a moveable object (e.g., a UAV or MAV) continuously captures images (e.g., captures image frames at 70 fps) using its onboard camera during movement of the movement of the moveable object. Each image frame is associated with a three dimensional position (xᵢ, yᵢ, zᵢ) of the moveable object at a time tᵢ when the image frame is captured. The series of images that are captured by the onboard camera are thus associated with different positions (e.g., z-positions) of the moveable object (e.g., a UAV) on the moveable object's movement path (e.g., flight path). In some embodiments, the processing of the images that are captured occurs onboard the moveable object in real-time, such that the results are immediately available for a suitable obstacle avoidance maneuver to be determined and executed by the moveable object. In some embodiments, the images are transmitted from the moveable object to a remote control unit (e.g., control unit 108) in real-time and are processed at the control unit.

The process for determining object distances based on images captured by a single camera at different positions along a z-direction (e.g., direction toward a predetermined destination of the moveable object) requires tracking of a feature point that corresponds to a real-world object across two or more images that have been captured at different locations (e.g., while the moveable object is at different z-positions) and determination of a change in scale between predefined pixel patches that corresponds to the feature point in the different images.

In some embodiments, the images captured by the onboard camera are grayscale images (e.g., images captured by an infrared camera). In some embodiments, the images captured by the onboard camera are color images, and the color images are converted to grayscale images before feature extraction is performed on the images. In some embodiments, the images are normalized, e.g. by reducing the image resolution, sharpened, blurred, cropped to a predetermined size, etc., before the extraction of image features is started.

In some embodiments, each image that is captured by the onboard camera is processed. In some embodiments, every x number of images (e.g., one in every ten images) is processed during the movement of the moveable object. In some embodiments, an image is processed only if the moveable object has moved by more than a threshold distance (e.g., 0.2 meters) since a previous image was processed. In some embodiments, an image is processed only if there has been a threshold amount of change in the image (e.g., an image is skipped if there is no change between the image and the last processed image, e.g., when the moveable object is sitting still).

When a first image is selected to be processed, and the first image is to serve as a base image to which subsequent images are compared, feature extraction processing is performed on the first image. The feature extraction processing produces one or more feature points at respective positions (e.g., x-y positions) in the first image. Extraction of feature points can be accomplished using one or more of existing feature extraction algorithms, such as Harris, SIFT, SURF, FAST, etc. In general, the feature points that are extracted from the image correspond to real-world objects (e.g., boundaries of real-world objects such as edges of a building, a person, a flag pole, etc.) that are captured in the image.

When a second image is selected to be processed, the same feature extraction process is performed on the second image, and one or more feature points are produced at various positions (e.g., x-y positions) in the second image as well.

In order to identify and track the same feature point across the first and the second images, a respective pixel patch is defined in the first image for each feature point. For example, in some embodiments, a square pixel patch with a size of 64×64 pixels is identified for each feature point with the feature point at the center of the pixel patch. For example, if the x-y coordinates of the feature point in the image is (x₀, y₀), the corresponding patch is defined as

Patch={(x₀+i,y₀+j)|j∈N,−31≤i,j≤32}

Other dimensions of the patches are also permitted. In some embodiments, the dimensions of the patches are selected based on the resolution and size of the image, and optionally, the average density of the feature points in the images. For example, when the resolution is high, a larger patch size is selected, and when the average density of pixels is high, smaller patch sizes are preferred.

The pixel patch corresponding to a respective feature point in the first image changes its size and possibly its x-y position relative to the pixel patch corresponding to the same respective feature point in the second image (e.g., as illustrated in FIG. 4). In order to track the same feature point and corresponding pixel patch across two images, an estimate based on minimization of an absolute difference between pixel values of the corresponding patches in the two images is performed. Specifically,

$$min f ( Δ x , Δ y , s ) = min {\sum }_{( x , y ) ∈ p} {‖ I ( x , y , 1 ) - {I}^{′} ( x + Δ x , y + Δ y , s ) ‖}^{2} ,$$

where s is the scale factor between the corresponding patches in the second image and the first image. The scale factor for the original patch in the first image is default to 1, and the scale factor for the updated patch in the second image is s. By minimizing the absolute difference between the pixel values of the original patch in the first image and the updated patch in the second image, when convergence of the calculation is achieved, the x-y shift (e.g., represented by Δx, and Δy) and the scale factor s are obtained.

FIG. 5 illustrates detection and tracking of feature points and matching corresponding image patches across two images that are captured by a single onboard camera at different positions along the movement path of the moveable object, in accordance with some embodiments.

The top portion of FIG. 5 shows two example frames (e.g., a base image 502a and a current image 502b) that have been processed for object depth determination. The image 502a is a base image that is captured by the onboard camera of the moveable object when the moveable object is at a first position (e.g., at (X0, Y0, Z0)) (e.g., at a time t0 during its movement toward its destination). The image 502b is a current image that is captured by the onboard camera of the moveable object when the moveable object is at a second position (X0+ΔX, Y0+ΔY, Z0+ΔZ) (e.g., at a time t+Δt during its movement toward its destination).

Squares shown on the base image 502a outline the image patches that have been defined based on feature points that are extracted from the base image. In accordance with the calculation for minimizing the absolute difference in pixel values between the original patch (e.g., patch 504a) and the updated patch (e.g., patch 504b) associated with the same feature point in both images, the position shift of each feature point and the scale of each patch are determined, provided that convergence of the solutions is achieved based on the initial values that is used to start the calculation. In some embodiments, when there is not sufficient distance between the positions at which the two images were captured, the change in scale may be too small, and convergence of the solution is not achievable or not achievable within a predetermined time limit (e.g., before the next image becomes available). If no solution is obtained, the feature point is marked, and the object depth of the feature point will be determined at a later time when more image frames are obtained. Squares shown on the current image 402b outline the updated image patches that correspond to the same feature points as those in the base image. A straight line links each pair of pixel patches that correspond to the same feature point in the two images. The lower portion of FIG. 5 is the same as the upper portion of FIG. 5, except that the underlying images are removed to show the feature points, their corresponding pixel patches, and the correspondence between the pixel patches for the same image feature between the two images. As illustrated by patch 504a and 504b, the feature point corresponding to these two patches moved in x-y position, the patches 504a and 504b are different by a scale factor s. Each feature point corresponds to a respective scale factor and position change.

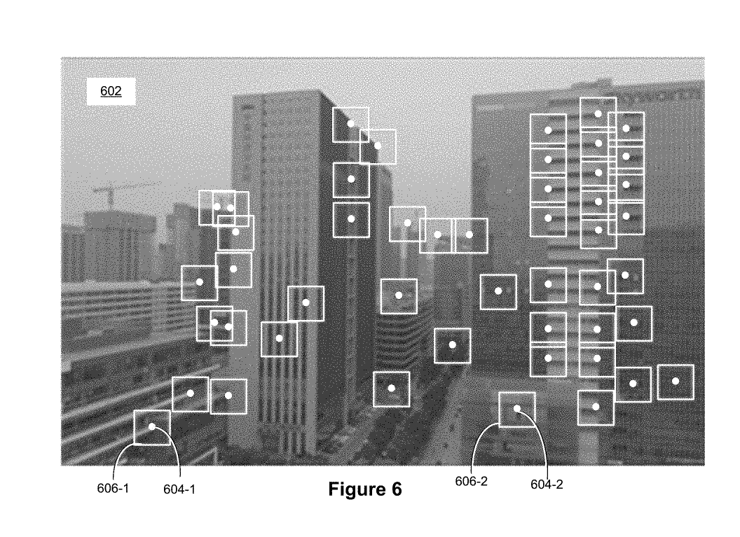

FIG. 6 shows the feature points (e.g., feature points 604) and corresponding pixel patches (e.g., 606) in another image 602.

In general, a greater distance between the positions at which the base image and the current image are captured produces an estimate of the scale factors with more accuracy because of a larger value of the scale factor. However, convergence is harder to achieve when the difference between the base image and the current image is too large.

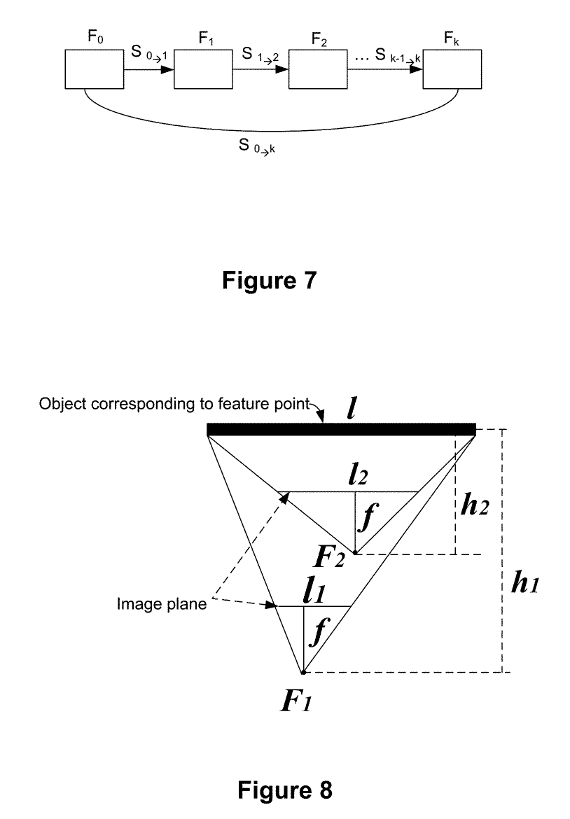

In some embodiments, in order to achieve convergence or achieve convergence more quickly in the calculation of the scale factors between the corresponding pixel patches in the current image and the base image, a suitable initial value for the scaling factor is provided to the minimization calculation. FIG. 7 illustrates the selection of an initial value for a scale factor s for an image patch corresponding to a detected feature point, in accordance with some embodiments.

As shown in FIG. 7, to obtain a suitable initial value for the scaling factor s, a series of intermediate frames between the base frame and the current frame are used. For each pair of adjacent frames (e.g., base frame F₀ and first intermediate frame F₁, first intermediate frame F₁ and second intermediate frame F₂, second intermediate frame F₂ and third intermediate frame F₃, . . . and the last frame Fₖ₋₁ before the current frame and the current frame Fₖ), the same feature point tracking and minimization of the absolute difference between the patches of the same feature point across the two adjacent images are performed (e.g., in the manner as discussed with respect to FIG. 5). Since the two frames are adjacent frames, the scale change s_{i→j} between the corresponding patches and the position change of the feature point in the two adjacent frames Fᵢ and Fⱼ are minimal, and can be solved with an initial value of 1. After the scale factor for each pair of adjacent frames have been obtained, the initial value for the scale factor for the original patch in the base frame and the corresponding updated patch in the current frame is a product of all the scale factors that have been obtained for each pair of adjacent pair of frames from the base frame to the current frame, as shown in FIG. 7. In other word, the initial value of the scale factor is

S_{0→k}=Πᵢ₌₀^{k-1}s_{i→i+1},

where s_{i→i+1} is the scale factor for the corresponding patches of the same feature point in two adjacent images Fᵢ and Fᵢ₊₁, and s_{0→k} is the initial value for the scale factor for the corresponding patches of the same feature point in the base image F₀ and the current image Fₖ.

In some embodiments, when the distance between the positions at which the base image and the current image were captured is sufficiently large, a new base frame is selected, and the calculation for object depth of a feature point as described above is performed relative to the feature points in the new base frame. In some embodiments, the current frame is the new base frame, and the original base frame is the historical base frame for images that are captured after the current image.

FIG. 8 illustrates the calculation of an object depth of a feature point based on a scale factor between corresponding sizes of a real-world object shown in two images that are captured at different positions F1 and F2, in accordance with some embodiments.

The object depth of a feature point is a z-distance between a real-world object represented by the feature point in an image and the optical center of the camera that captured the image. In general, the object depth is relative to the real-world position of the camera at the time that the image was captured. In the present disclosure, unless otherwise specified, object depth of a feature point is calculated to be relative to the current position of the moveable object.

In FIG. 8, the respective x-z locations of F1 and F2 represent the respective x-z locations of the moveable object (or more specifically, the x-z locations of the optical center of the onboard camera) when the images (e.g., the base image and the current image) are captured. The focal length of the camera is represented by f. The actual lateral dimension (e.g., the x-dimension) of an imaged object is represented by l. The images of the object show the lateral dimensions to be l₁ and l₂, respectively, in the base image and in the current image. The actual distance from the optical center of the camera to the object is h1 when the base image was captured, and is h2 when the current image is captured. The object depth of the image feature that corresponds to the object is h1 relative to the camera at F1, and is h2 relative to the camera at F2.

As shown in FIG. 8, in accordance with the principle of similarity,

$$\frac{{l}_{1}}{f} = \frac{l}{{h}_{1}} , \frac{{l}_{2}}{f} = \frac{l}{{h}_{2}} , \to \frac{{l}_{2}}{{l}_{1}} = \frac{{h}_{1}}{{h}_{2}} .$$

Since the scale factor between the corresponding patches for the feature point is

$${s}_{1 \to 2} = \frac{{h}_{2}}{{h}_{1}} ,$$

the change in position of the moveable object between the capture of the base image and the capture of the current image is Δh=h₁=h₂, which can be obtained from the moveable object's navigation system log or calculated based on the speed of the moveable object and the time between the capture of the base image and the capture of the current image. Based on the correlated equations:

$$\frac{{l}_{2}}{{l}_{1}} = \frac{{h}_{1}}{{h}_{2}} and Δ h = h 1 = h 2 ,$$

the values of h₁ and h₂ can be calculated. The value of h₁ is the object depth of the image feature representing the object in the base image, and the value of h₂ is the object depth of the image feature representing the object in the current image. Correspondingly, the z-distance between the object and the camera is h₁ when the base image was taken, and is h₂ when the current image was taken.

In some scenarios, particularly when a feature point that is being tracked across the images corresponds to an edge of a real-world object, the depth estimation is not very accurate because the assumption that the whole pixel patch surrounding the feature point has the same depth is incorrect. In some embodiments, in order to improve the accuracy of the object depth estimation for a respective feature point in a current image, the object depth estimation is performed for multiple images between the base image and the current image for the respective feature point that exists in these multiple images. The object depth values obtained for these multiple images are filtered (e.g., by a Kalman filter, or running average) to obtain an optimized, more accurate estimate.

After the object depth of a feature point is obtained based on the process described above, three dimensional coordinates of the feature point are determined in a coordinate system centered at the onboard camera. Suppose that a feature point has an x-y position of (u,v) in the current image, and an object depth of h in the current image, the three-dimensional coordinates of an object that corresponds to the feature point are (x, y, z) in a real-world coordinate system centered at the onboard camera (or more generally, at the moveable object) are calculated as follows: z=h; x=(u−u₀)*z/f; y=(v−v0)*z/f, where (u0, v0) are the x-y coordinates of the optical center of the camera when the image was captured, e.g., based on an external reference frame.

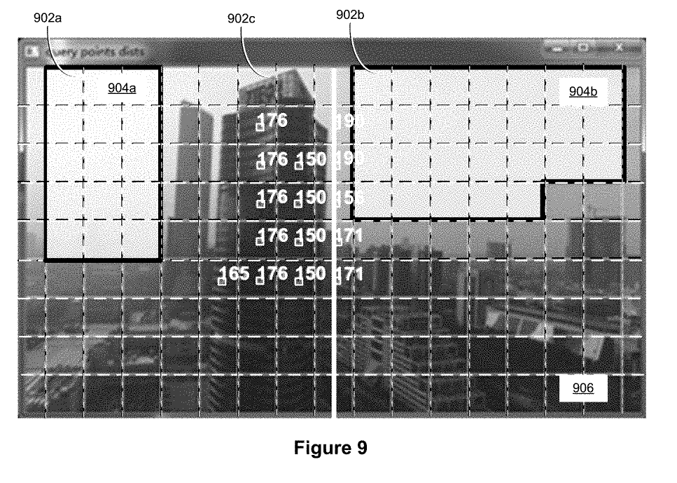

FIG. 9 illustrates detection of open sky and characterization of detected obstacles based on estimated object depths of feature points in an image, in accordance with some embodiments.

In some embodiments, to prepare for obstacle detection and avoidance (and removal of false feature points), the images are segmented to identify regions that correspond to open sky (or open region or space that does not contain obstacles to block the movement of the moveable object), and other regions that correspond to occupied space (or that do not correspond to open sky). The regions that are identified as open sky typically do not contain a feature point. In some embodiments, any image feature in the regions that are identified as open sky is ignored or deleted from the object depth estimation process.

In some embodiments, before the feature extraction is started, a respective image (e.g., image 906) that is to be processed is first divided into a plurality of sub-regions, such as by a linear grid, e.g., as shown in FIG. 9. Each sub-region (e.g., sub-regions 902) of the image corresponds to a grid cell in the grid. The image feature information and brightness of each sub-region is analyzed to determine whether the sub-region of the image corresponds to open sky. For example, in some embodiments, when the feature information in a respective sub-region is less than a threshold amount (e.g., when there is minimal pixel variations), and the overall brightness of the sub-region is greater than a predetermined threshold brightness level, it is determined that the respective sub-region corresponds to open sky. If a respective sub-region does not meet the standards to quality as corresponding to open sky, the respective sub-region is considered not to be corresponding to open sky. As shown in FIG. 9, regions 904a (e.g., including 15 contiguously located sub-regions) and 904b (e.g., including 26 contiguously located sub-regions) are determined to be corresponding to open sky, and the rest of the regions in the image 906 are determined to be corresponding to occupied space.

In some embodiments, once a region of the image is determined to be corresponding to open sky, the object depth determination for feature points in these regions do not require averaging over results obtained from tracking the feature point across more than the base image and the current image. In some embodiments, the detection of open sky in the images also facilitates subsequent selection obstacle avoidance strategies that are to be executed.

In some embodiments, the estimated object depths of feature points are utilized immediately in obstacle detection and subsequent selection of obstacle avoidance strategies. Specifically, the current image that has been processed is divided into a plurality of sub-regions, if it has not already been divided into sub-regions (e.g., by a rectangular grid) during the process for detecting open sky regions in the image. It is then determined whether each of the sub-region is occupied by an object or a portion of an object, and if so, what the depth of the object or the portion of the object is. If it is determined that a sub-region is not occupied by any object, then the depth of sub-region is denoted as “−1”. If some sub-regions are already determined to be corresponding to open sky, the depths of those regions are also denoted as “−1” and the depth calculation for those sub-regions is skipped.

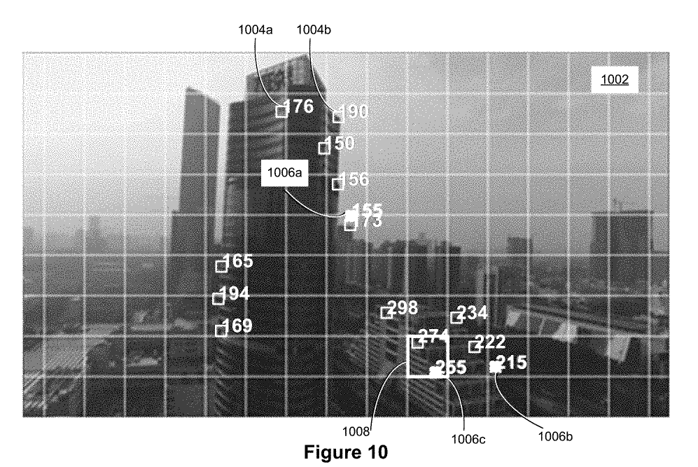

FIG. 10 illustrates projection of feature points from a base image and a previous base image onto a current image, in accordance with some embodiments.

In some embodiments, the basic process for determining the object depth associated with a sub-region in a current image is as follows. First, all of the feature points in the base frame for which the depth calculation have successfully returned a valid result (e.g., convergence of the value for the scale factor s has been achieved) are identified. Then, those feature points are projected onto the current frame to obtain the x-y position of projection in the current image. If a base frame and a current frame were captured at two positions that are fairly close to each other, it is possible that the depth calculation for some of the feature points will not converge to produce a valid result. In such a case, a historical base frame is identified (for example, a base frame that was used before the current base frame is selected). The historical base frame that includes some of the same feature points as the base frame, and these feature points are projected onto the current frame as well. FIG. 10 illustrates the locations of the feature points that have been projected on the current frame 1002. The unfilled squares 1004 represent the locations of feature points that are projected from the base frame, and the solid squares 1006 represent the locations of feature points that are projected from the previous base image. The object depth of the feature points are marked next to the squares associated with the projections of the feature points. The projection is calculated based on the following formula:

$$s ( \begin{matrix}u \\ v \\ 1\end{matrix} ) = ( \begin{matrix}f & 0 & {u}_{0} \\ 0 & f & {v}_{0} \\ 0 & 0 & 1\end{matrix} ) R ( \begin{matrix}{x}_{k} \\ {y}_{k} \\ {z}_{k}\end{matrix} ) + t$$

For each sub-region, if the sub-region has previously been determined to correspond to open sky, the depth of the sub-region is designated as “−1”; otherwise, the object depth of the sub-region relative to the moveable object (e.g., the optical center of the camera lens) is estimated based on the estimated object depths of the feature points that are projected onto the sub-region. As shown in FIG. 10, sub-region 1008 includes projections of two feature points, one from the base frame and one from the previous base frame.

In some embodiments, a weighted sum of the object depths of all the feature points that have been projected onto the sub-region is calculated. For example, suppose that the feature points that have been projected onto a sub-region are {(uᵢ, vⱼ)}_{i=1 . . . k}, where k is the total number of feature points that have been projected onto the sub-region; and the estimated object depths of the feature points are {zᵢ}ᵢ₌₁₋ₖ. The estimated object depth of the sub-region from the location of the moveable object is calculated using the following equations:

$$D ( {u}_{c} , {v}_{c} ) = \frac{{\sum }_{i = 1}^{K} {ω}_{i} {z}_{i}}{{\sum }_{i = 1}^{K} {ω}_{i}}$$

$${ω}_{i} = \frac{{g}_{i}}{\sqrt{{( {u}_{i} - {u}_{c} )}^{2} + {( {v}_{i} - {v}_{c} )}^{2}}} ,$$

where D is the object depth of the center of sub-region, (u_{c}, v_{c}) is the coordinates of the center of the sub-region, gi is a weight given to the object depth of a respective feature point i, based on whether the feature point is from the base frame or from the previous base frame. In general, smaller weights are given to the feature points from the current base frame as compared to the weights given to the feature points from the previous base frame. In addition, in some embodiments, as the number of intermediate frames between the base frame and the current frame increases (e.g., the z-distance between the positions at which the base frame and the current frame were captured by the camera), the weights given to the feature points from the previous base frame are decreased.

In some embodiments, another method for estimating the object depth of the center of the sub-region is used. For example, if three or more feature points are projected onto a sub-region, three feature points (e.g., feature points q₁, q₂, and q₃) that are projected closest to the center of the sub-region and that are not co-linear to one another are identified. Based on these three feature points that have been identified (e.g., feature points q₁, q₂, and q₃), a plane is defined. Then, the center p of the sub-region is projected onto the plane as p′, and the object depth of p′, the projection of the center of the sub-region on the plane, is calculated. The object depth of p′ is treated as the object depth of the sub-region as a whole.

In some embodiments, if a sub-region does not have any feature points being projected onto it (e.g., the object depths of the feature points cannot be determined at this time) and the sub-region does not correspond to open sky, the object depth of the sub-region is estimated using the following approximation. Based on the assumption that an obstacle that is represented in a respective sub-region is not suspended in the air or supported by structures that are hollow below the respective sub-region, the object depth of the respective sub-region takes on the object depth of another sub-region that is directly above the respective sub-region. For example, if the object depth of the feature point that corresponds to a building's top edge has been determined, the object depth of the sub-region that includes that feature point can be determined. If other sub-regions that lie below the sub-region that corresponds to the building's top edge do not include feature points for which object depths have been determined, these other sub-regions are considered to be located at the same object depth as the sub-region that represents the top of the building. As shown in FIG. 9, multiple sub-regions in the 7th column from the left take on the same object depth of 176 meters as the top sub-region (e.g., the sub-region at row 2 and column 7 of the grid) that represents the top of the main body of the building.

In some embodiments, the sub-regions that are located below a representation of the moveable object (e.g., a projection of the moveable object onto the current frame, or combination of the sub-regions that overlap with the projection) are ignored in the object depth calculation, because usually the moveable object does not lower its altitude in order to avoid an obstacle. As shown in FIG. 9, the estimated object depths of the sub-regions in the current image are shown. Sub-regions (e.g., sub-regions 904) that correspond to open sky have object depths designated as −1. The bottom portion of the current image that is below the representation of the moveable object (e.g., the 3 rows in the lower half of the image) is not considered in the obstacle detection process.

While the moveable object is moving and continues to capture new images, the obstacle detection is performed substantially in real-time (e.g., either using the onboard obstacle detection logic or at a remote control station). Sub-regions in a current image that overlap with a representation of the moveable object are identified. If the object depth of a respective sub-region among the identified sub-regions is greater than the z-distance from the moveable object to the destination of the moveable object, the respective sub-region will not be encountered by the moveable object on its way to its destination. Thus, such a sub-region is not an obstacle. If the object depth of a respective sub-region among the identified sub-regions is less than the z-distance from the moveable object to the destination of the moveable object, the respective sub-region will be encountered by the moveable object on its way to its destination. Thus, the respective sub-region corresponds to an obstacle that needs to be avoided.

The object-depth of a sub-region is represented by the minimum object depth of all pixels in the sub-region. A representation of the moveable object in the current image is a projection of the moveable object in the image or a combination of the sub-regions that overlaps with the projection (e.g., a rectangular region that includes 2×2 sub-regions at the center of the current image (e.g., region 418 in FIG. 4)).

In some embodiments, as soon as an obstacle (e.g., one or more obstacles) is detected in the current image, suitable obstacle avoidance strategies are selected and executed. If no obstacle is detected in the current movement path, the movement of the moveable object continues and image capturing also continues. The process for detecting obstacle is repeated based on the next image and the new location of the moveable object (e.g., extracting feature points, determining object depths of feature points, determining object depths of sub-regions in the current image, determining whether an obstacle exists in the current movement path of the moveable object, etc.). If an obstacle is detected based on the analysis of the next image, obstacle avoidance strategy is selected based on the new determination, and the adjusted movement path may be further adjusted accordingly.

In some embodiments, after it is determined that an obstacle exists in the current movement path of the moveable object, and that obstacle avoidance is needed, a direction of movement for obstacle avoidance is selected. In some embodiments, the moveable object has three general directions to move to avoid an obstacle, namely, up, left, and right directions. In some embodiments, if the current altitude of the moveable object is more than a threshold altitude (e.g., 200 meters above ground), sideway movements are preferred over upward movements in avoiding the obstacle; and, if the current altitude of the moveable object is less than the threshold altitude, then upward movements are preferred over sideway movements in avoiding the obstacle. However, in a situation where upward movement is prohibited by another obstacle, then sideway movement is selected as the way to avoid the obstacles.

In some embodiments, when the moveable object is too close to the obstacle (e.g., the z-distance between the moveable object and the obstacle is smaller than a threshold distance); then emergency obstacle avoidance maneuvers are executed. In some embodiments, emergency obstacle avoidance maneuvers include a sharp stop, followed by a straight pull up to a predetermined altitude (e.g., an altitude that is above the upper edge of the obstacle). After the moveable object has reached the predetermined altitude above the upper edge of the obstacle, the moveable object maintains the predetermined altitude until the moveable object has moved past the obstacle. After the moveable object has moved past the obstacle, the moveable object drops to the previous altitude it had right before the emergency obstacle avoidance maneuver was executed, and continues to move forward toward its destination.

In some embodiments, the emergency avoidance maneuver that involves upward movement is not available, and side movement is used in obstacle avoidance. For example, when the moveable object is closer to the obstacle than a predetermined distance threshold, the moveable object tries to stop immediately, and then move to the left or right until the moveable object moves past the obstacle, and then the moveable object moves forward in the original movement direction until the movement object moves past the obstacle in the forward direction. After that, the moveable object moves right or left until the moveable object returns to its original movement path. Once the moveable object has returned to its original path past the obstacle, the moveable object continues to move forward in the original movement direction.

As disclosed herein, obstacle detection based on the images captured by a single onboard camera has a detection range of several hundred meters, much longer than the detection range of other conventional techniques that are commonly implemented on a moveable object, such as a UAV. For this reason, a more graceful and gradual obstacle avoidance maneuver can be executed after an obstacle is detected during the movement of the moveable object.

In some embodiments, if an obstacle is detected before the moveable object has gotten too close to the obstacle (e.g., the z-distance between the obstacle and the moveable object is greater than the predetermined distance threshold for emergency obstacle avoidance maneuvers), moveable object prioritizes sideway maneuvers over upward maneuvers to avoid the obstacle. This is different from the usual preference in the case where emergency obstacle avoidance maneuvers are needed.

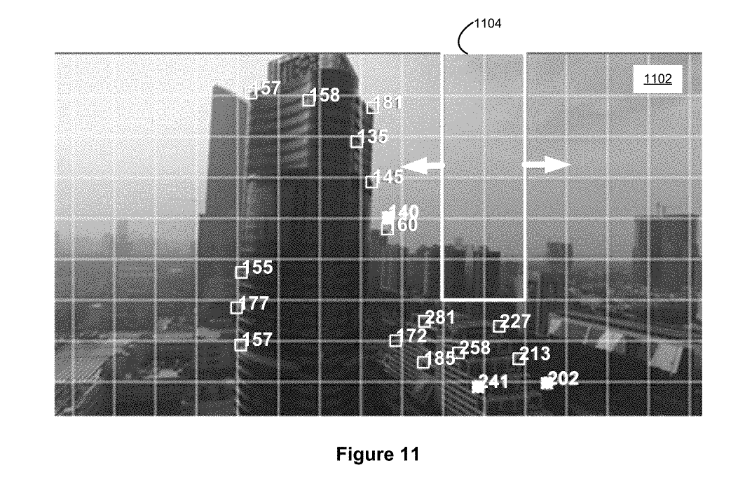

In some embodiments, the moveable object or the control unit searches for a window of clearance to the left or right of the obstacle in the current image to determine if it is possible for the moveable object to avoid the obstacle by moving sideways. FIG. 11 illustrate a process for searching for a window of clearance to avoid an obstacle, in accordance with some embodiments.

As shown in FIG. 11, a search window 1104 is defined in the current image, and the search window has a width that is greater than the width of the representation of the moveable object in the current image. The search window has a lower boundary that is at the lower edge of the representation of the moveable object in the current image. The search window is moved left or right sub-region-by-sub-region (e.g., cell-by-cell) to determine if the search window corresponds to a space that is free of obstacles. The respective object depths of feature points that are projected onto the image are indicated by the numbers next to the squares that represent the projected location of the feature point(s). If any sub-region in the search window have an object depth that is smaller than the z-distance between the moveable object and its destination plus a buffer distance that corresponds to an estimated thickness of the obstacle in the z-direction (e.g., 60 meters), then it is determined that the search window at the current position would not be clear and would cause a collision. If all sub-regions in the search window have object depths that are greater than the z-distance between the moveable object and its destination plus the buffer distance, or otherwise correspond to open sky, then it is determined that the search window at the current position would be clear (e.g., the search window at the present location is also referred to as a window of clearance) and obstacle avoidance can be accomplished if the moveable object moves toward the current position of the search window (e.g., aiming the moveable object at the x-center of the search window). If all sub-regions on the left and right of the obstacle are exhausted and a window of clearance cannot be found, side movement cannot be used to avoidance the obstacle, and upward movement is used to avoid the obstacle instead.

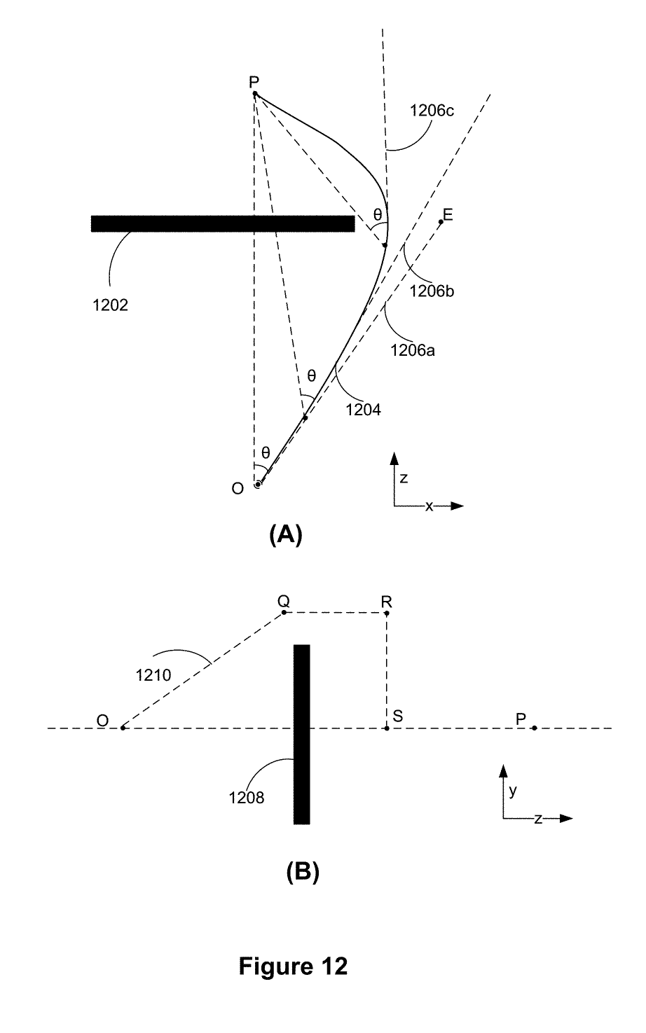

FIG. 12 illustrates paths of long-range obstacle avoidance maneuvers (as opposed to emergency obstacle avoidance maneuvers) that are implemented upon detection of an obstacle, in accordance with some embodiments.

FIG. 12A illustrates the trajectory 1204 of the moveable object when the moveable object tries to use side movement to avoid an obstacle 1202, in accordance with some embodiments. As shown in FIG. 12A, a straight line OE linking the current position O of the moveable object and a point of clearance E (e.g., a point within the window of clearance) that is slightly beyond the right edge of the obstacle (e.g., 5 meters outside of the right edge) is at an angle θ to the straight line OP linking the current position P of the moveable object and the destination P of the moveable object. In some embodiments, in order to adjust the movement direction of the moveable object to realize such a trajectory, the moveable object increases a rightward component of its velocity from zero or a suitable positive value, such that the velocity of the moveable object is in the same direction as the line OE. After the moveable object starts to move in a direction toward the point E, the moveable object continues to modify its heading (e.g., by continuously adjusting the direction of its velocity) to maintain the angle θ between its heading direction and the line OP linking the moveable object and the destination of the moveable object.

FIG. 12B illustrates the trajectory 1210 of the moveable object when the moveable object tries to use an upward movement to avoid an obstacle 1208, in accordance with some embodiments. As shown in FIG. 12B, when the obstacle 1208 is detected, the moveable object gradually moves toward a point Q above the upper edge of the obstacle, without making a sudden stop. For example, the moveable object moves upward and at the same time continues to move forward with the original speed. The speed of the upward movement and the speed of the forward movement are adjusted such that the trajectory of the moveable object follows the straight line that links the current position O of the moveable object and a point of clearance Q that is a predetermined distance above the upper edge of the obstacle. In some embodiments, in order to adjust the movement direction of the moveable object to realize such a trajectory, the moveable object increases an upward component of its velocity from zero or a suitable positive value, such that the velocity of the moveable object is in the same direction as the line OQ. After the moveable object has reached the altitude that is the predetermined distance above the upper edge of the obstacle (e.g., the altitude of the point of clearance Q), the moveable object stops the upward movement and continues to move forward at the same altitude. Once the moveable object has moved past the obstacle in the z-direction (e.g., to a point R), the moveable object drops to the original altitude and continues to move forward towards the destination P.

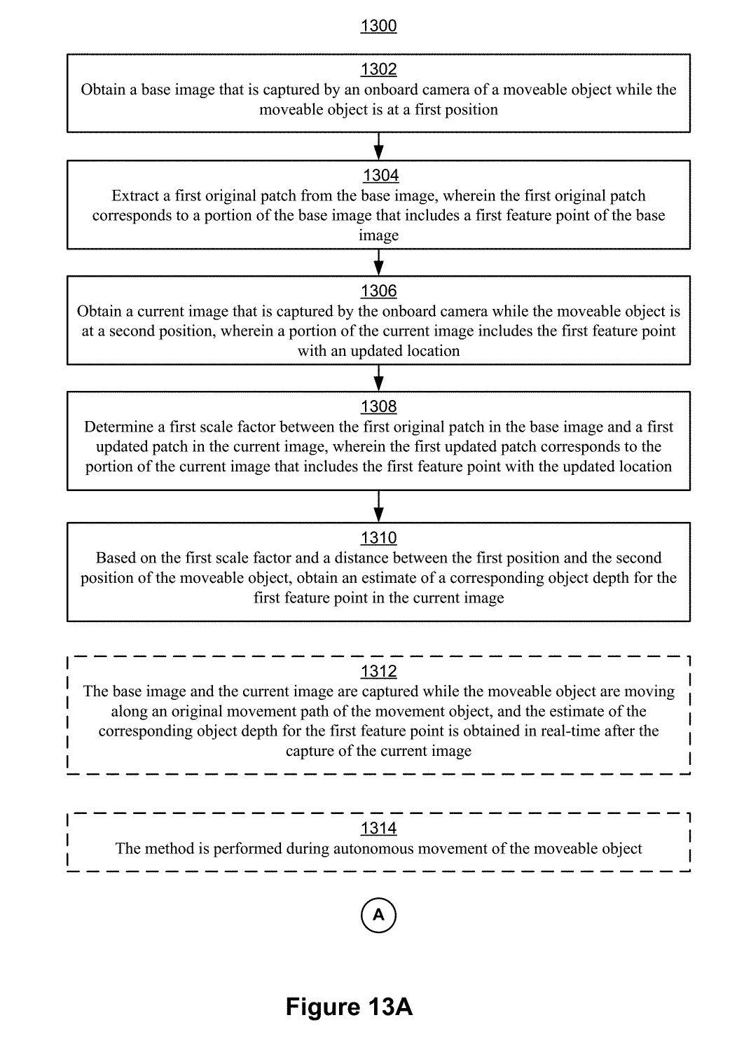

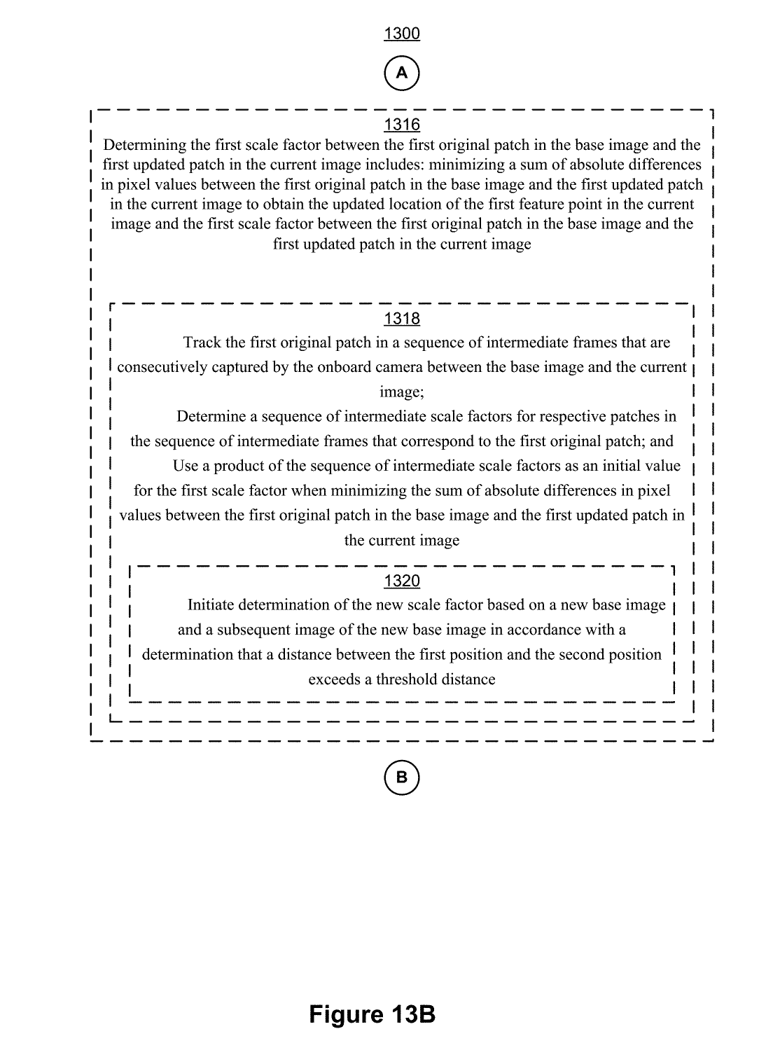

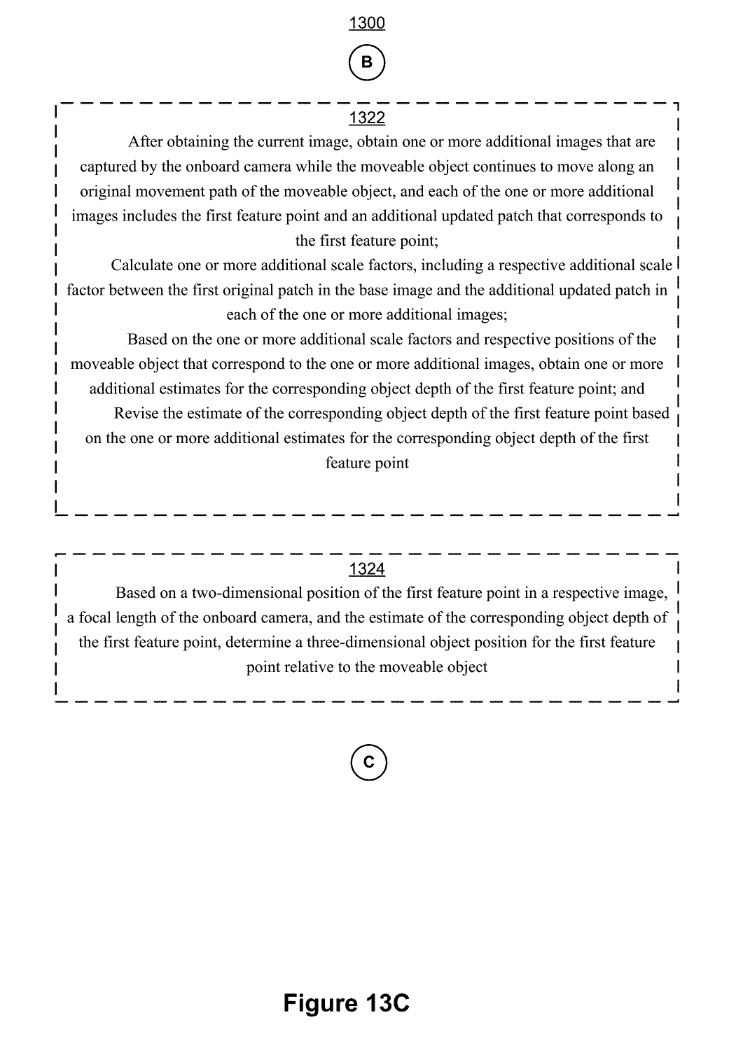

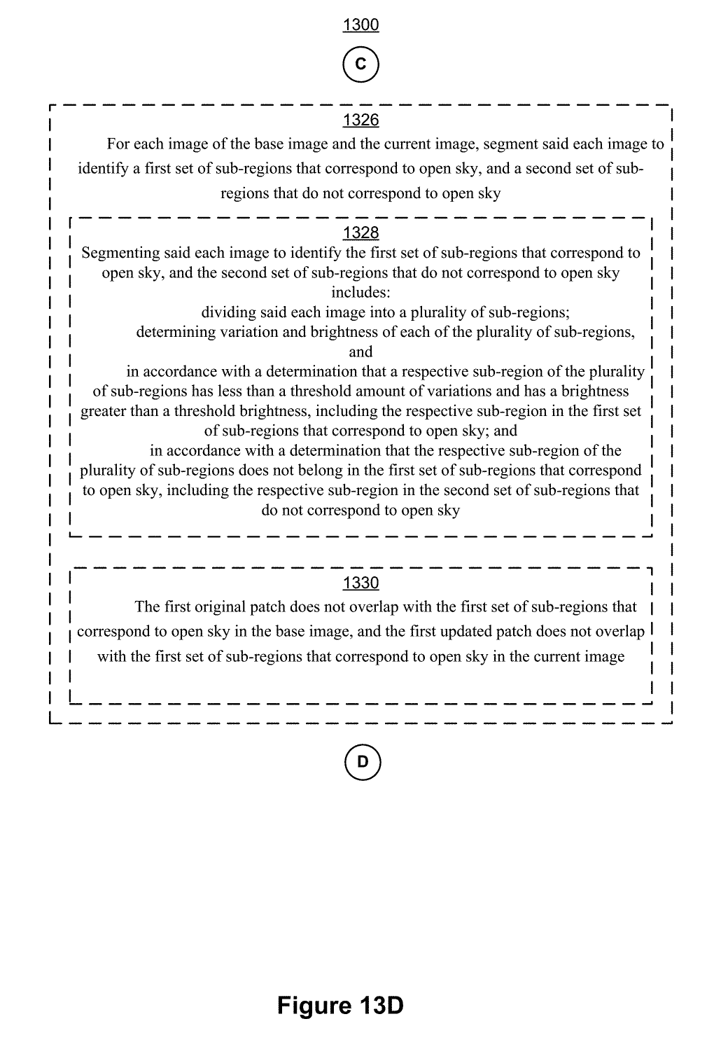

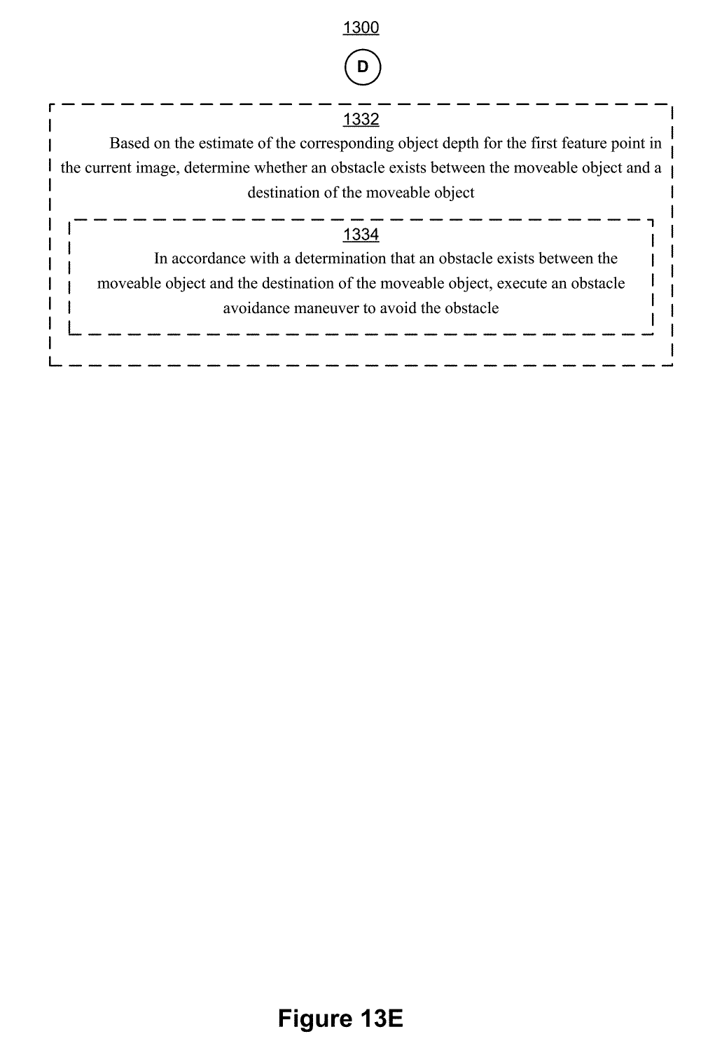

FIGS. 13A-13E are a flow diagram illustrating a method 1300 of obstacle detection based on images captured by a single camera, in accordance with some embodiments. The method 1300 is performed at a device, such as the moveable object 102 or the control unit 108. The device includes an optional imaging device (e.g., imaging device 218), a storage device (e.g., the memory 204), and one or more processors 202 coupled to the optional imaging device and the storage device. The method is illustrated in FIGS. 4-12 and accompanying descriptions.

The device obtains (1302) a base image that is captured by an onboard camera of a moveable object (e.g., a UAV, such as an MAV) while the moveable object is at a first position (e.g., a first position along an original movement path of the moveable object). The device extracts (1304) a first original patch from the base image, wherein the first original patch corresponds to a portion of the base image that includes a first feature point of the base image (e.g., a pixel patch of 64-64 pixels centered at the first feature point). This is illustrated in image 502a in FIG. 5. The device obtains (1306) a current image that is captured by the onboard camera while the moveable object is at a second position (e.g., a second position along the original movement path of the moveable object), wherein a portion of the current image includes the first feature point with an updated location. The device determines (1308) a first scale factor between the first original patch (e.g., 504a) in the base image (e.g., 502a) and a first updated patch (e.g., 504b) in the current image (e.g., 504b), wherein the first updated patch corresponds to the portion of the current image that includes the first feature point with the updated location. Based on the first scale factor and a distance between the first position and the second position of the moveable object, the device obtains (1310) an estimate of a corresponding object depth for the first feature point in the current image, in accordance with the principle shown in FIG. 8.

In some embodiments, the base image and the current image are (1312) captured while the moveable object are moving along an original movement path of the moveable object, and the estimate of the corresponding object depth for the first feature point is obtained in real-time after the capture of the current image.

In some embodiments, the device is the moveable object or a component thereof. In some embodiments, the device is a remote control unit that is in communication with the moveable object. In some embodiments, the method is (1314) performed during autonomous movement of the moveable object.

In some embodiments, determining the first scale factor between the first original patch in the base image and the first updated patch in the current image includes (1316): minimizing a sum of absolute differences in pixel values between the first original patch in the base image and the first updated patch in the current image to obtain the updated location of the first feature point in the current image and the first scale factor between the first original patch in the base image and the first updated patch in the current image.

In some embodiments, the device tracks (1318) the first original patch in a sequence of intermediate frames that are consecutively captured by the onboard camera between the base image and the current image; the device determines a sequence of intermediate scale factors for respective patches in the sequence of intermediate frames that correspond to the first original patch; and the device uses a product of the sequence of intermediate scale factors as an initial value for the first scale factor when minimizing the sum of absolute differences in pixel values between the first original patch in the base image and the first updated patch in the current image. This illustrated in FIG. 7 and accompanying descriptions, for example.

In some embodiments, the device initiates (1320) determination of the new scale factor based on a new base image and a subsequent image of the new base image in accordance with a determination that a distance between the first position and the second position exceeds a threshold distance. For example, after the moveable object has traveled for a threshold amount of distance, a new base image is selected, and the previous base image is now considered a historical base image, and image features in subsequently captured images are tracked relative to the new base image.

In some embodiments, after obtaining the current image, the device obtains (1322) one or more additional images that are captured by the onboard camera while the moveable object continues to move along an original movement path of the moveable object, and each of the one or more additional images includes the first feature point and an additional updated patch that corresponds to the first feature point; the device calculates one or more additional scale factors, including a respective additional scale factor between the first original patch in the base image and the additional updated patch in each of the one or more additional images; based on the one or more additional scale factors and respective positions of the moveable object that correspond to the one or more additional images, the device obtains one or more additional estimates for the corresponding object depth of the first feature point; and the device revises the estimate of the corresponding object depth of the first feature point based on the one or more additional estimates for the corresponding object depth of the first feature point. (Note, in some embodiments, this optimization is not performed for feature point that fall within portions of the image that are identified as open sky).

In some embodiments, based on a two-dimensional position of the first feature point in a respective image (e.g., the current image captured at the second position), a focal length of the onboard camera, and the estimate of the corresponding object depth of the first feature point (e.g., relative to the second position), the device determines (1324) a three-dimensional object position for the first feature point relative to the moveable object (e.g., at the second position).

In some embodiments, for each image of the base image and the current image (and all intermediate images between the base image and the current image, and any additional images captured after the current image), the device segments (1326) said each image to identify a first set of sub-regions that correspond to open sky, and a second set of sub-regions that do not correspond to open sky. This is illustrated in FIG. 9 and accompanying descriptions, for example.

In some embodiments, segmenting said each image to identify the first set of sub-regions that correspond to open sky, and the second set of sub-regions that do not correspond to open sky includes (1328): dividing said each image into a plurality of sub-regions (e.g., a grid of square cells); determining variation and brightness of each of the plurality of sub-regions, and in accordance with a determination that a respective sub-region of the plurality of sub-regions has less than a threshold amount of variations and has a brightness greater than a threshold brightness, including the respective sub-region in the first set of sub-regions that correspond to open sky; and in accordance with a determination that the respective sub-region of the plurality of sub-regions does not belong in the first set of sub-regions that correspond to open sky, including the respective sub-region in the second set of sub-regions that do not correspond to open sky. This is illustrated in FIG. 9 and accompanying descriptions, for example.

In some embodiments, the first original patch does not (1330) overlap with the first set of sub-regions that correspond to open sky in the base image, and the first updated patch does not overlap with the first set of sub-regions that correspond to open sky in the current image. For example, if a sub-region corresponds to open sky, it does not correspond to an obstacle, and therefore, there is no need to estimate the object depth of the sub-region.

In some embodiments, based on the estimate of the corresponding object depth for the first feature point in the current image, the device determines (1332) whether an obstacle exists between the moveable object and a destination of the moveable object.

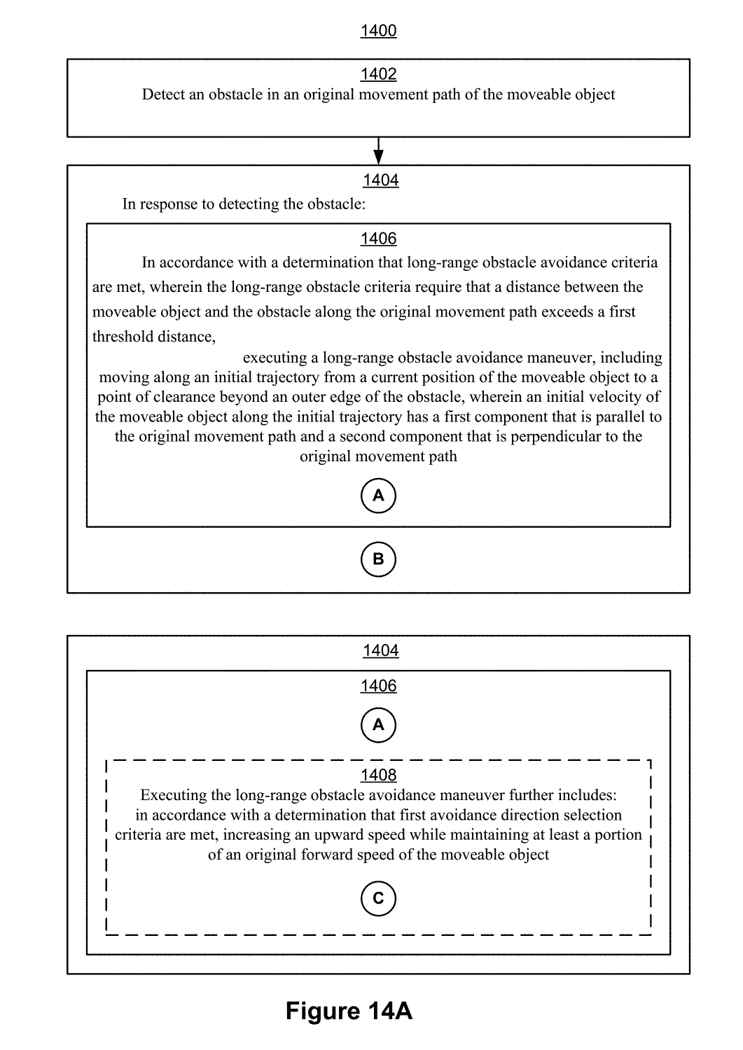

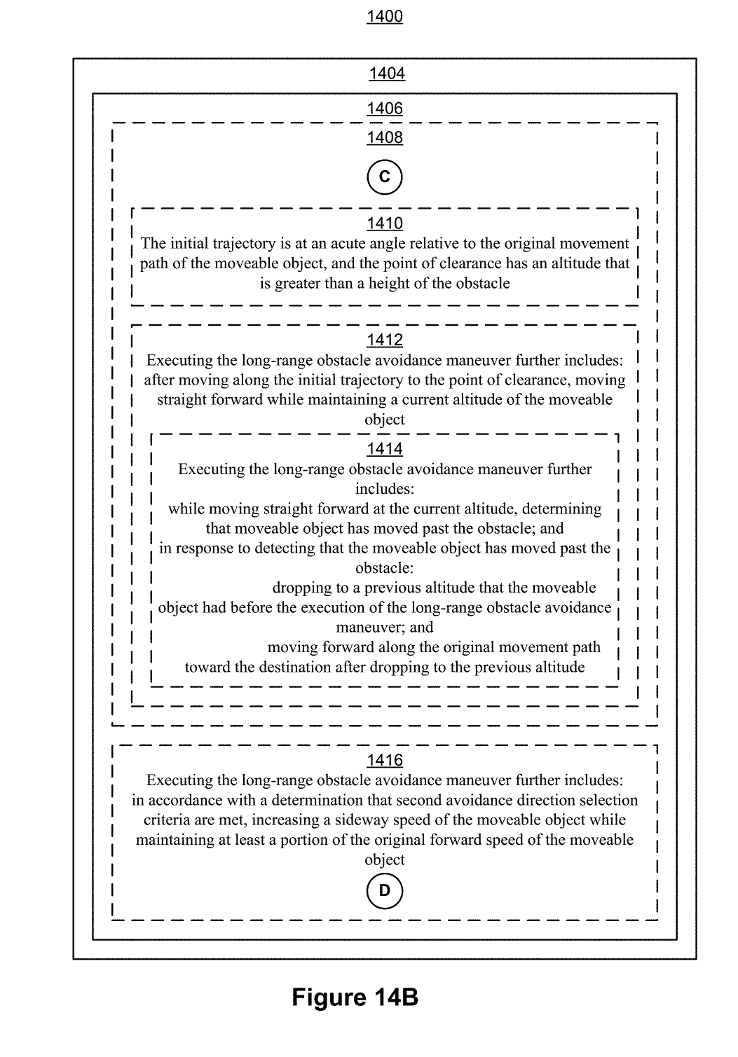

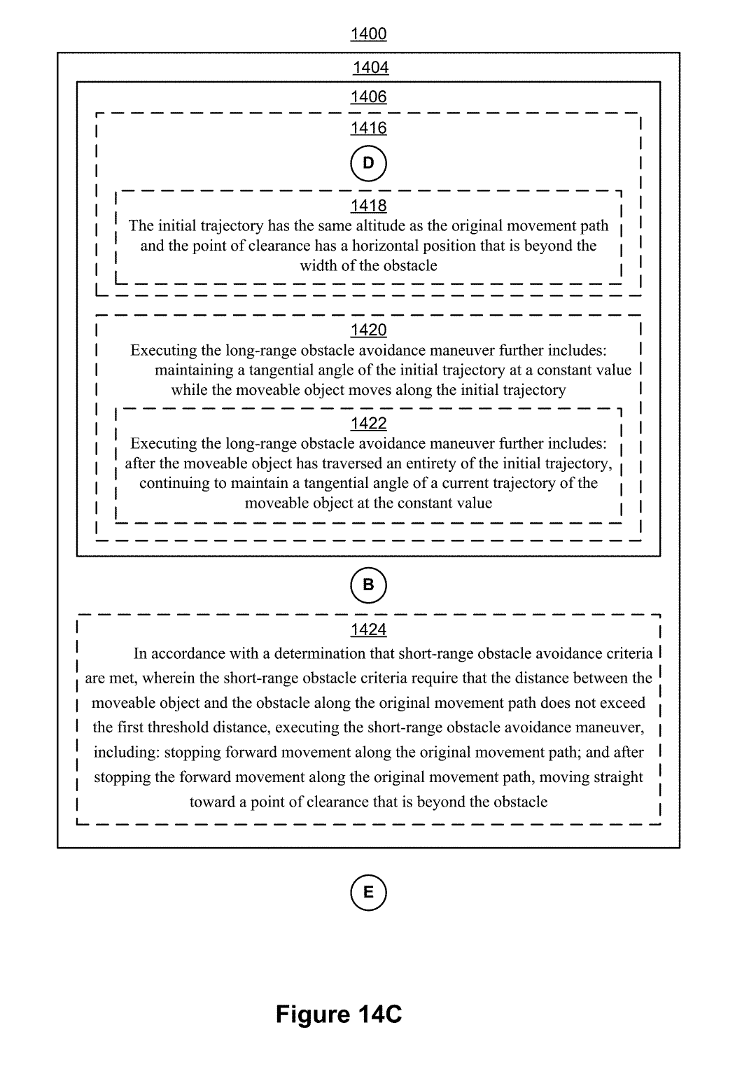

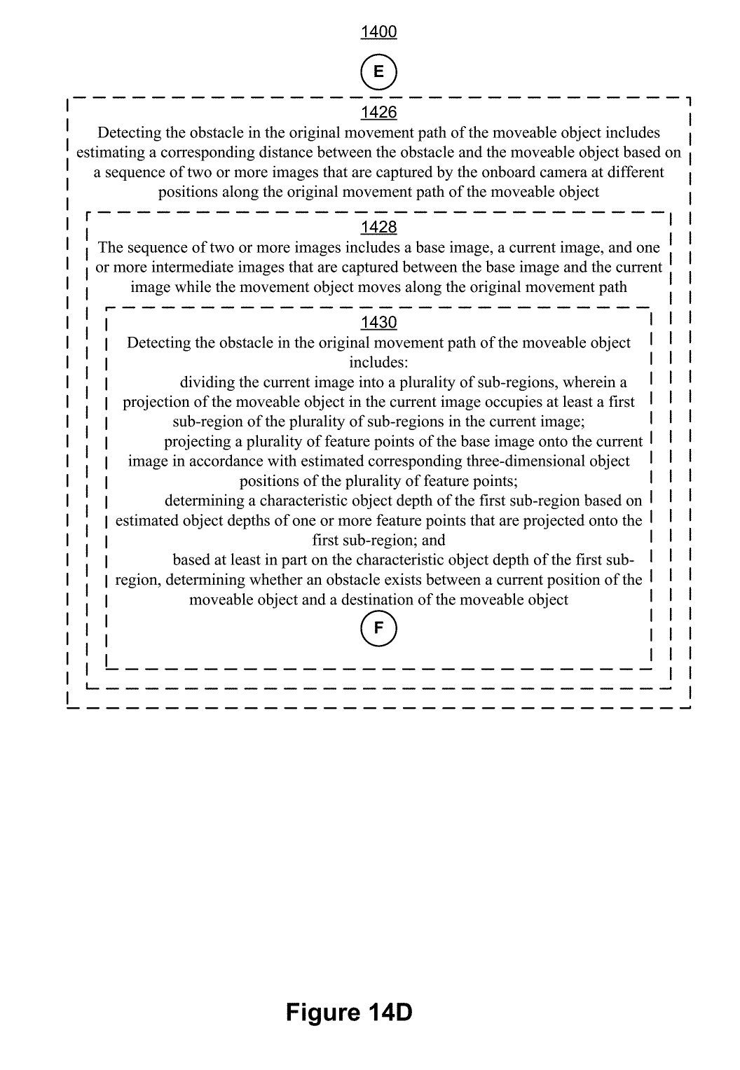

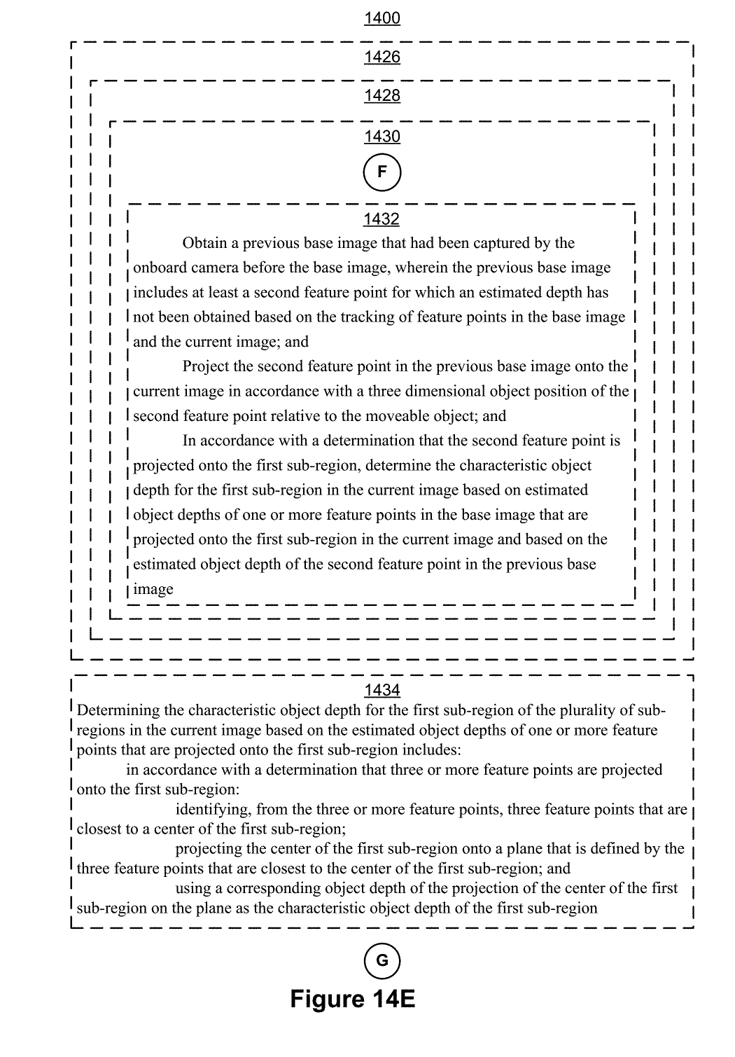

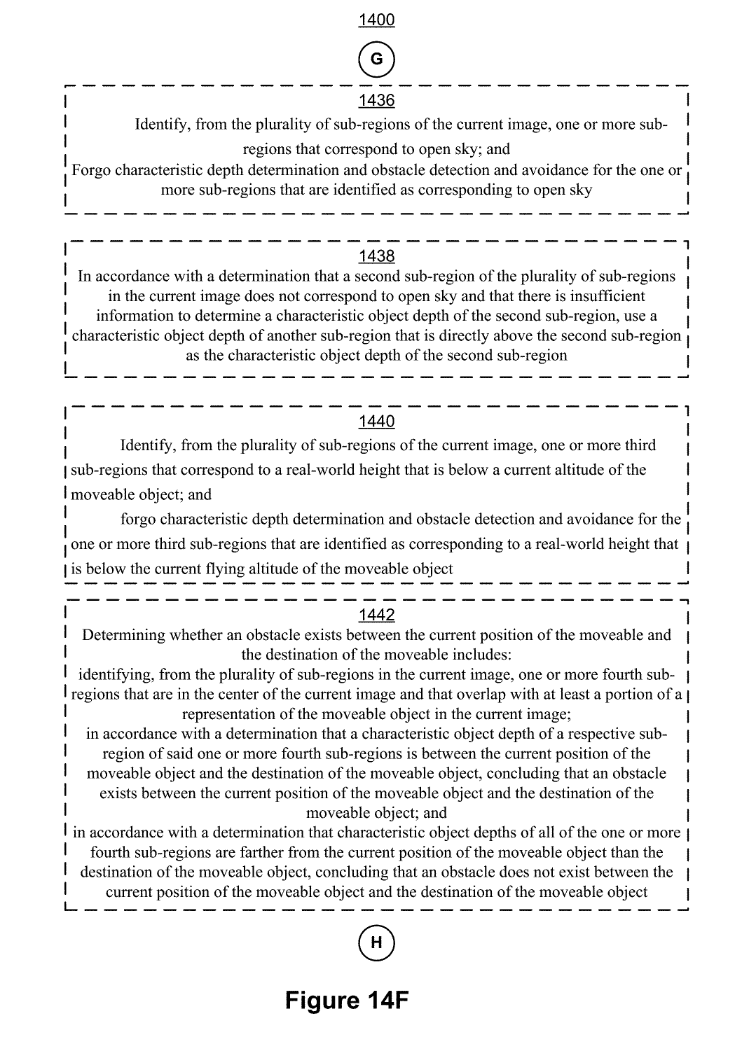

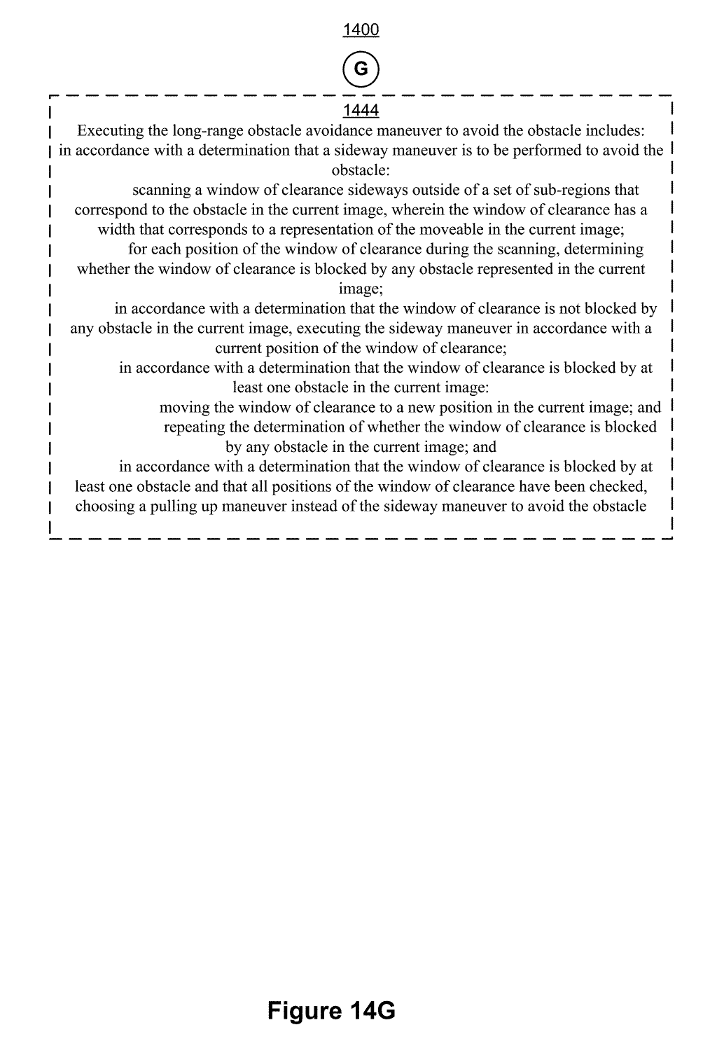

In some embodiments, in accordance with a determination that an obstacle exists between the moveable object and the destination of the moveable object, the device executes (1334) an obstacle avoidance maneuver to avoid the obstacle. More details of the selection and execution of the obstacle avoidance maneuver are described in more detail with respect to FIGS. 14A-14G.

FIGS. 14A-14G are a flow diagram illustrating a method 1400 of obstacle avoidance, in accordance with some embodiments. The method 1400 is performed at a device, such as the moveable object 102. The device includes an imaging device (e.g., imaging device 218), a storage device (e.g., the memory 204), and one or more processors 202 coupled to the optional imaging device and the storage device. The method is illustrated in FIGS. 4-12 and accompanying descriptions.

The device detects (1402) an obstacle in an original movement path of the moveable object (e.g., during movement of the moveable object, an object is detected on the movement path between the moveable object and a destination of the movement object). In response to detecting the obstacle (1404): in accordance with a determination that long-range obstacle avoidance criteria are met, wherein the long-range obstacle criteria require that a distance between the moveable object and the obstacle along the original movement path exceeds a first threshold distance (e.g., 20 meters, etc.), the device executes (1406) a long-range obstacle avoidance maneuver, including moving along an initial trajectory (e.g., along line OE in FIG. 12A, or along line OQ in FIG. 12B) from a current position of the moveable object to a point of clearance beyond an outer edge of the obstacle, wherein an initial velocity of the moveable object along the initial trajectory has a first component that is parallel to the original movement path (e.g., a z-component) and a second component that is perpendicular to the original movement path (e.g., an x-component in sideway obstacle avoidance maneuvers, or a y-component in upward obstacle avoidance maneuvers) (e.g., the initial trajectory is at an acute angle relative to the original movement path of the moveable object, e.g., as shown in FIG. 12).

In some embodiments, executing the long-range obstacle avoidance maneuver further includes (1408): in accordance with a determination that first avoidance direction selection criteria are met (e.g., when the original altitude of the moveable object is less than a threshold altitude (e.g., less than 200 meters above ground)), the device increases an upward speed while maintaining at least a portion of an original forward speed of the moveable object. For example, in some embodiments, when the current altitude of the moveable object is relatively low, upward movements are preferred over sideway movements in achieving obstacle avoidance.

In some embodiments, the initial trajectory is (1410) at an acute angle relative to the original movement path of the moveable object, and the point of clearance has an altitude that is greater than a height of the obstacle (e.g., as shown in FIG. 12B).

In some embodiments, executing the long-range obstacle avoidance maneuver further includes (1412): after moving along the initial trajectory to the point of clearance (e.g., a point that has an altitude of 5 meters above the height of the obstacle), the device moving straight forward while maintaining a current altitude of the moveable object (e.g., moving along line QR in FIG. 12B).

In some embodiments, executing the long-range obstacle avoidance maneuver further includes (1414): while moving straight forward at the current altitude, determining that moveable object has moved past the obstacle; and in response to detecting that the moveable object has moved past the obstacle: the device dropping to a previous altitude that the moveable object had before the execution of the long-range obstacle avoidance maneuver; and moving forward along the original movement path toward the destination after dropping to the previous altitude. For example, in some embodiments, the moveable object drops straight downward to its original altitude once the moveable object has moved past the obstacle (e.g., movement along the line RS in FIG. 12B). In some embodiments, the moveable object optionally maintains a non-zero forward speed after passing the obstacle, and the moveable object follows a trajectory that has both a downward component and a forward component toward the original movement path.

In some embodiments, executing the long-range obstacle avoidance maneuver further includes (1416): in accordance with a determination that second avoidance direction selection criteria are met (e.g., when the original altitude of the moveable object is less than a threshold altitude (e.g., less than 200 meters above ground)), increasing a sideway speed of the moveable object (e.g., speed to the left or right of the moveable object) while maintaining at least a portion of the original forward speed of the moveable object. For example, in some embodiments, sideway movements are preferred over upward movement in accomplishing obstacle avoidance when the moveable object is at a relatively high altitude.

In some embodiments, the initial trajectory has (1418) the same altitude as the original movement path and the point of clearance (e.g., point E in FIG. 12A) has a horizontal position that is beyond the width of the obstacle.

In some embodiments, executing the long-range obstacle avoidance maneuver further includes (1420): maintaining a tangential angle of the initial trajectory at a constant value while the moveable object moves along the initial trajectory, e.g., as shown in FIG. 12A.

In some embodiments, executing the long-range obstacle avoidance maneuver further includes (1422): after the moveable object has traversed an entirety of the initial trajectory, continuing to maintain a tangential angle of a current trajectory of the moveable object at the constant value (e.g., until reaching the destination point), e.g., as shown in FIG. 12A.

In some embodiments, in response to detecting the obstacle: in accordance with a determination that short-range obstacle avoidance criteria are met, wherein the short-range obstacle criteria require that the distance between the moveable object and the obstacle along the original movement path does not exceed the first threshold distance (e.g., 20 meters, etc.), the device executes (1424) the short-range obstacle avoidance maneuver (e.g., an emergency obstacle avoidance maneuver), including: stopping forward movement along the original movement path; and after stopping the forward movement along the original movement path, moving straight toward a point of clearance that is beyond the obstacle (e.g., a point above the top edge or outside a left or right edge of the obstacle). For example, after coming to a complete stop, the moveable object moves straight up at a 90 degree relative to the original movement path of the moveable object.

In some embodiments, detecting the obstacle in the original movement path of the moveable object includes (1426) estimating a corresponding distance between the obstacle and the moveable object based on a sequence of two or more images that are captured by the onboard camera (e.g., while the moveable object is moving along the original movement path) at different positions along the original movement path of the moveable object. More details are provided in FIG. 13A-13E and accompanying descriptions, for example.

In some embodiments, the sequence of two or more images includes (1428) a base image, a current image, and one or more intermediate images that are captured between the base image and the current image while the movement object moves along the original movement path.

In some embodiments, detecting the obstacle in the original movement path of the moveable object includes (1430): dividing the current image into a plurality of sub-regions (e.g., grid cells), wherein a projection of the moveable object in the current image occupies at least a first sub-region of the plurality of sub-regions in the current image; projecting a plurality of feature points of the base image onto the current image in accordance with estimated corresponding three-dimensional object positions of the plurality of feature points; determining a characteristic object depth of the first sub-region based on estimated object depths of one or more feature points that are projected onto the first sub-region; and based at least in part on the characteristic object depth of the first sub-region, determining whether an obstacle exists between a current position of the moveable object and a destination of the moveable object. This is illustrated in FIGS. 9-11, for example.

In some embodiments, the device identifies a plurality of feature points from the base image; and for a respective feature point of the plurality of feature points of the base image, the device estimates the corresponding three-dimensional object position of the respective feature point relative to the moveable object, based on tracking of the respective feature point in the one or more intermediate images and the current image.

In some embodiments, estimating the corresponding three-dimensional object position of the respective feature point relative to the moveable object includes: calculating the corresponding three-dimensional object position of the respective feature point based on an estimated object depth of the respective feature point, a position of the respective feature point in the current image relative to a center of the current image, and a focal length of the onboard camera.

In some embodiments, calculating the estimated object depth of the respective feature point includes: determining a scale factor between an original patch around the respective feature point in the base image and an updated patch around the respective feature point in the current image; and estimating the object depth of the respective feature point based on the scale factor and a distance between positions of the moveable object when the base image and the current image are captured. More details of this are provided in FIG. 13A-13E and accompanying descriptions, for example.

In some embodiments, the device obtains (1432) a previous base image that had been captured by the onboard camera before the base image, wherein the previous base image includes at least a second feature point for which an estimated depth has not been obtained based on the tracking of feature points in the base image and the current image; and the device projects the second feature point in the previous base image onto the current image in accordance with a three dimensional object position of the second feature point relative to the moveable object; and in accordance with a determination that the second feature point is projected onto the first sub-region, the device determines the characteristic object depth for the first sub-region in the current image based on estimated object depths of one or more feature points in the base image that are projected onto the first sub-region in the current image and based on the estimated object depth of the second feature point in the previous base image (e.g., after the estimated depths have been adjusted by the change in the inflight position of the moveable object at the current time). This is illustrated in FIG. 10 and accompanying descriptions, for example.

In some embodiments, determining the characteristic object depth for the first sub-region in the current image based on estimated object depths of the one or more feature points in the base image that are projected onto the first sub-region in the current image and based on the estimated object depth of the second feature point in the previous base image includes: calculating a weighted sum of the estimated object depths of the feature points of the base image and the previous base image that are projected onto the first sub-region, wherein a respective weight of each said feature point is determined based on a distance between the projection of said feature point in the current image and a center of the current image (e.g., the weight w is inversely proportional to the distance).

In some embodiments, the respective weight of the second feature point of the previous base image that is projected onto the first sub-region is adjusted by a multiplier that is decreased with increasing number of intermediate images between the base image and the current image.

In some embodiments, determining the characteristic object depth for the first sub-region of the plurality of sub-regions in the current image based on the estimated object depths of one or more feature points that are projected onto the first sub-region includes (1434): in accordance with a determination that three or more feature points are projected onto the first sub-region: identifying, from the three or more feature points, three feature points that are closest to a center of the first sub-region; projecting the center of the first sub-region onto a plane that is defined by the three feature points that are closest to the center of the first sub-region; and using a corresponding object depth of the projection of the center of the first sub-region on the plane as the characteristic object depth of the first sub-region.

In some embodiments, the device identifies (1436), from the plurality of sub-regions of the current image, one or more sub-regions that correspond to open sky; and the device forgoes characteristic depth determination and obstacle detection and avoidance for the one or more sub-regions that are identified as corresponding to open sky.

In some embodiments, in accordance with a determination that a second sub-region of the plurality of sub-regions in the current image does not correspond to open sky and that there is insufficient information to determine a characteristic object depth of the second sub-region, the device uses (1438) a characteristic object depth of another sub-region that is directly above the second sub-region as the characteristic object depth of the second sub-region.

In some embodiments, the device identifies (1440), from the plurality of sub-regions of the current image, one or more third sub-regions that correspond to a real-world height that is below a current altitude of the moveable object; and the device forgoes characteristic depth determination and obstacle detection and avoidance for the one or more third sub-regions that are identified as corresponding to a real-world height that is below the current flying altitude of the moveable object.

In some embodiments, determining whether an obstacle exists between the current position of the moveable object and the destination of the moveable object includes (1442): identifying, from the plurality of sub-regions in the current image, one or more fourth sub-regions that are in the center of the current image and that overlap with at least a portion of a representation of the moveable object in the current image (e.g., a rectangle with dimensions corresponding to the size and shape of the MAV projected onto the current image); in accordance with a determination that a characteristic object depth of a respective sub-region of said one or more fourth sub-regions is between the current position of the moveable object and the destination of the moveable object, concluding that an obstacle exists between the current position of the moveable object and the destination of the moveable object; and in accordance with a determination that characteristic object depths of all of the one or more fourth sub-regions are farther from the current position of the moveable object than the destination of the moveable object, concluding that an obstacle does not exist between the current position of the moveable object and the destination of the moveable object.

In some embodiments, executing the long-range obstacle avoidance maneuver to avoid the obstacle includes (1444): in accordance with a determination that a sideway maneuver is to be performed to avoid the obstacle: scanning a window of clearance sideways outside of a set of sub-regions that correspond to the obstacle in the current image, wherein the window of clearance has a width that corresponds to a representation of the moveable object in the current image; for each position of the window of clearance during the scanning, determining whether the window of clearance is blocked by any obstacle represented in the current image; in accordance with a determination that the window of clearance is not blocked by any obstacle in the current image, executing the sideway maneuver in accordance with a current position of the window of clearance (e.g., a point of clearance is selected within the window of clearance (e.g., at the center of the window of clearance)); in accordance with a determination that the window of clearance is blocked by at least one obstacle in the current image: moving the window of clearance to a new position in the current image; and repeating the determination of whether the window of clearance is blocked by any obstacle in the current image; and in accordance with a determination that the window of clearance is blocked by at least one obstacle and that all positions of the window of clearance have been checked, choosing a pulling up maneuver instead of the sideway maneuver to avoid the obstacle. This is illustrated in FIG. 11 and accompanying descriptions, for example.

FIG. 15 shows a functional block diagram of an electronic device 1500 configured in accordance with the principles of the various described embodiments. The functional blocks of the device are, optionally, implemented by hardware, software, or a combination of hardware and software to carry out the principles of the various described embodiments. It is understood by persons of skill in the art that the functional blocks described in FIG. 15 are, optionally, combined or separated into sub-blocks to implement the principles of the various described embodiments. Therefore, the description herein optionally supports any possible combination or separation or further definition of the functional blocks described herein.

As shown in FIG. 15, an electronic device 1500 includes an imaging unit 1502 configured to capture images; a movement unit 1504 configured to actuate and cause movement of the electronic device; communication unit 1506 configured to send and receive data and instruction to and from a remote control device (e.g., control unit 108); a storage unit 1508 (e.g., memory, or SSD) configured to store instructions and images, and a processing unit 1510 coupled to the imaging unit 1502, the movement unit 1504, the communication unit 1506, and the storage unit 1508. In some embodiments, the processing unit includes feature extraction unit 1512, feature tracking unit 1514, depth estimation unit 1516, obstacle detection unit 1318, and obstacle avoidance unit 1520.

In some embodiments, the processing unit is configured to: obtain a base image that is captured by an onboard camera of a moveable object while the moveable object is at a first position; extract a first original patch from the base image, wherein the first original patch corresponds to a portion of the base image that includes a first feature point of the base image; obtain a current image that is captured by the onboard camera while the moveable object is at a second position, and wherein a portion of the current image includes the first feature point with an updated location; determine a first scale factor between the first original patch in the base image and a first updated patch in the current image, wherein the first updated patch corresponds to the portion of the current image that includes the first feature point with the updated location; and based on the first scale factor and a distance between the first position and the second position of the moveable object, obtain an estimate of a corresponding object depth for the first feature point in the current image. The processing unit is further configured to perform other operations described in FIGS. 13A-13E and FIGS. 14A-14G, and accompanying descriptions, using the various functional units of the device 1500.

In some embodiments, the processing unit is configured to: detect an obstacle in an original movement path of the moveable object; in response to detecting the obstacle: in accordance with a determination that long-range obstacle avoidance criteria are met, wherein the long-range obstacle criteria require that a distance between the moveable object and the obstacle along the original movement path exceeds a first threshold distance, execute a long-range obstacle avoidance maneuver, including moving along an initial trajectory from a current position of the moveable object to a point of clearance beyond an outer edge of the obstacle, wherein an initial velocity of the moveable object along the initial trajectory has a first component that is parallel to the original movement path and a second component that is perpendicular to the original movement path. The processing unit is further configured to perform other operations described in FIGS. 13A-13E and FIGS. 14A-14G, and accompanying descriptions, using the various functional units of the device 1500.

Many features of the technology disclosed herein can be performed in, using, or with the assistance of hardware, software, firmware, or combinations thereof. Consequently, features of the present technology may be implemented using a processing system. Exemplary processing systems (e.g., processor(s) 202, 302) include, without limitation, one or more general purpose microprocessors (for example, single or multi-core processors), application-specific integrated circuits, application-specific instruction-set processors, field-programmable gate arrays, graphics processors, physics processors, digital signal processors, coprocessors, network processors, audio processors, encryption processors, and the like.

Features of the present technology can be implemented in, using, or with the assistance of a computer program product, such as a storage medium (media) or computer readable storage medium (media) having instructions stored thereon/in which can be used to program a processing system to perform any of the features presented herein. The storage medium (e.g., the memory 204, 304) can include, but is not limited to, any type of disk including floppy disks, optical discs, DVD, CD-ROMs, microdrive, and magneto-optical disks, ROMs, RAMs, EPROMs, EEPROMs, DRAMs, VRAMs, DDR RAMs, flash memory devices, magnetic or optical cards, nanosystems (including molecular memory ICs), or any type of media or device suitable for storing instructions and/or data.

Stored on any one of the machine readable medium (media), features of the present technology can be incorporated in software and/or firmware for controlling the hardware of a processing system, and for enabling a processing system to interact with other mechanism utilizing the results of the present technology. Such software or firmware may include, but is not limited to, application code, device drivers, operating systems, and execution environments/containers.

Communication systems as referred to herein (e.g., the communication system 206, 314) optionally communicate via wired and/or wireless communication connections. For example, communication systems optionally receive and send RF signals, also called electromagnetic signals. RF circuitry of the communication systems convert electrical signals to/from electromagnetic signals and communicate with communications networks and other communications devices via the electromagnetic signals. RF circuitry optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. Communication systems optionally communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. Wireless communication connections optionally use any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSDPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 302.11a, IEEE 302.11ac, IEEE 302.11ax, IEEE 302.11b, IEEE 302.11g and/or IEEE 302.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), spread spectrum technology such as FASST or DESST, or any other suitable communication protocol, including communication protocols not yet developed as of the filing date of this document.

While various embodiments of the present technology have been described above, it should be understood that they have been presented by way of example, and not limitation. It will be apparent to persons skilled in the relevant art that various changes in form and detail can be made therein without departing from the spirit and scope of the disclosure.

The present technology has been described above with the aid of functional building blocks illustrating the performance of specified functions and relationships thereof. The boundaries of these functional building blocks have often been arbitrarily defined herein for the convenience of the description. Alternate boundaries can be defined so long as the specified functions and relationships thereof are appropriately performed. Any such alternate boundaries are thus within the scope and spirit of the disclosure.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description of the present technology has been provided for the purposes of illustration and description. It is not intended to be exhaustive or to limit the disclosure to the precise forms disclosed. The breadth and scope of the present technology should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the invention be defined by the following claims and their equivalence.

What is claimed is:

1. A method of obstacle detection, comprising, at a device having one or more processors and memory:
obtaining a base image that is captured by an onboard camera of a moveable object while the moveable object is at a first position;
extracting an original patch from the base image, wherein the original patch corresponds to a portion of the base image that includes a feature point of the base image;
obtaining a current image that is captured by the onboard camera while the moveable object is at a second position, wherein a portion of the current image includes the feature point with an updated location;
determining a scale factor between the original patch in the base image and an updated patch in the current image, wherein the updated patch corresponds to the portion of the current image that includes the feature point with the updated location; and
based on the scale factor and a distance between the first position and the second position of the moveable object, obtaining an estimate of a corresponding object depth for the feature point in the current image.

2. The method of claim 1, wherein the base image and the current image are captured while the moveable object are moving along an original movement path of the movement object, and the estimate of the corresponding object depth for the feature point is obtained in real-time after the current image is captured.

3. The method of claim 1, wherein the device is the moveable object or a component of the moveable object.

4. The method of claim 1, wherein the device is a remote controller that is in communication with the moveable object.

5. The method of claim 1, wherein the method is performed during autonomous movement of the moveable object.

6. The method of claim 1, wherein determining the scale factor between the original patch in the base image and the updated patch in the current image includes:
minimizing a sum of absolute differences in pixel values between the original patch in the base image and the updated patch in the current image to obtain the updated location of the feature point in the current image and the scale factor between the original patch in the base image and the updated patch in the current image.

7. The method of claim 6, further comprising:
tracking the original patch in a sequence of intermediate frames that are consecutively captured by the onboard camera between the base image and the current image; and
determining a sequence of intermediate scale factors for respective patches in the sequence of intermediate frames that correspond to the original patch;
wherein minimizing the sum of the absolute differences in the pixel values between the original patch in the base image and the updated patch in the current image includes using a product of the sequence of intermediate scale factors as an initial value for the scale factor.

8. The method of claim 7, further comprising:
initiating determination of a new scale factor based on a new base image and a subsequent image subsequent to the new base image in accordance with a determination that a distance between the first position and the second position exceeds a threshold distance.

9. The method of claim 1, further comprising:
after obtaining the current image, obtaining one or more additional images that are captured by the onboard camera while the moveable object continues to move along an original movement path of the moveable object, each of the one or more additional images including the feature point and an additional updated patch that corresponds to the feature point;
calculating one or more additional scale factors, including a respective additional scale factor between the original patch in the base image and the additional updated patch in each of the one or more additional images;
based on the one or more additional scale factors and respective one or more positions of the moveable object that correspond to the one or more additional images, obtaining one or more additional estimates for the corresponding object depth of the feature point; and
revising the estimate of the corresponding object depth of the feature point based on the one or more additional estimates for the corresponding object depth of the feature point.

10. The method of claim 1, further comprising:
based on a two-dimensional position of the feature point in the base image or the current image, a focal length of the onboard camera, and the estimate of the corresponding object depth of the feature point, determining a three-dimensional object position for the feature point relative to the moveable object.

11. The method of claim 1, further comprising:
segmenting one of the base image and the current image to identify a first set of sub-regions that correspond to open sky and a second set of sub-regions that do not correspond to open sky.

12. The method of claim 11, wherein segmenting the one of the base image and the current image includes:
dividing the one of the base image and the current image into a plurality of sub-regions;
determining variation and brightness of each of the plurality of sub-regions; and
determining whether a respective sub-region of the plurality of sub-regions belongs to the first set or the second set by:
determining that the respective sub-region belongs to the first set in accordance with a determination that the respective sub-region has less than a threshold amount of variations and has a brightness greater than a threshold brightness; or
determining that the respective sub-region belongs to the second set in accordance with a determination that the respective sub-region does not belong to the first set.

13. The method of claim 11, wherein the original patch does not overlap with the first set of sub-regions that correspond to open sky in the base image, and the updated patch does not overlap with the first set of sub-regions that correspond to open sky in the current image.

14. The method of claim 1, further comprising:
based on the estimate of the corresponding object depth for the feature point in the current image, determining whether an obstacle exists between the moveable object and a destination of the moveable object.

15. The method of claim 14, further comprising:
in accordance with a determination that the obstacle exists between the moveable object and the destination of the moveable object, executing an obstacle avoidance maneuver to avoid the obstacle.

16. A system, comprising:
a storage device; and
one or more processors coupled to the storage device, the one or more processors being configured to:
obtain a base image that is captured by an onboard camera of a moveable object while the moveable object is at a first position;
extract an original patch from the base image, wherein the original patch corresponds to a portion of the base image that includes a feature point of the base image;
obtain a current image that is captured by the onboard camera while the moveable object is at a second position, and wherein a portion of the current image includes the feature point with an updated location;
determine a scale factor between the original patch in the base image and an updated patch in the current image, wherein the updated patch corresponds to the portion of the current image that includes the feature point with the updated location; and
based on the scale factor and a distance between the first position and the second position of the moveable object, obtain an estimate of a corresponding object depth for the feature point in the current image.

17. The system of claim 16, wherein the one or more processors are further configured to:
based on a two-dimensional position of the feature point in the base image or the current image, a focal length of the onboard camera, and the estimate of the corresponding object depth of the feature point, determine a three-dimensional object position for the feature point relative to the moveable object.

18. The system of claim 16, wherein the one or more processors are further configured to:
based on the estimate of the corresponding object depth for the feature point in the current image, determine whether an obstacle exists between the moveable object and a destination of the moveable object.

19. The system of claim 18, wherein the one or more processors are further configured to:
in accordance with a determination that the obstacle exists between the moveable object and the destination of the moveable object, execute an obstacle avoidance maneuver to avoid the obstacle.

20. An Unmanned Aerial Vehicle (UAV), comprising:
a propulsion system;
an onboard camera;
a storage device; and
one or more processors coupled to the propulsion system, the onboard camera, and the storage device, the one or more processors being configured to:
obtain a base image that is captured by the onboard camera while the UAV is at a first position;
extract an original patch from the base image, wherein the original patch corresponds to a portion of the base image that includes a feature point of the base image;
obtain a current image that is captured by the onboard camera while the UAV is at a second position along the original movement path of the UAV, and wherein a portion of the current image includes the feature point with an updated location;
determine a scale factor between the original patch in the base image and an updated patch in the current image, wherein the updated patch corresponds to the portion of the current image that includes the feature point with the updated location; and
based on the scale factor and a distance between the first position and the second position of the UAV, obtaining an estimate of a corresponding object depth for the feature point in the current image.
